(19) United States
(12) Patent Application Publication
(10) Pub. No.: US 2026/0140758 A1
(43) Pub. Date: May 21, 2026

(54) METHODS FOR CONTEXT-AWARE ADAPTIVE INFERENCING FOR MULTIPLE ACTIVE MACHINE-TASKS THAT CONSTITUTE A MACHINE-TYPE APPLICATION

(71) Applicant: InterDigital Patent Holdings, Inc., Wilmington, DE (US)

(72) Inventors: Subhramoy Mohanti, Santa Clara, CA (US); Sharon Ladron de Guevara Contreras, Irvine, CA (US); Hyomin Choi, Sunnyvale, CA (US); Fabien Racape, San Francisco, CA (US); Shahab Hamidi-Rad, Sunnyvale, CA (US)

(73) Assignee: InterDigital Patent Holdings, Inc., Wilmington, DE (US)

(21) Appl. No.: 18/949,462

(22) Filed: Nov. 15, 2024

(51) Int. Cl. G06F 9/48; H04W 24/10

(52) U.S. Cl. CPC G06F 9/485; H04W 24/10; G06F 2209/5019

(57) ABSTRACT

A method implemented by a wireless transmit/receive unit (WTRU) may include determining machine-task context information for execution of a machine-type task. The machine-task context information may include at least one of application performance information, WTRU performance information, edge server performance information, or network (NW) performance information. NW-related parameters may be received, and may include at least one of channel bandwidth, WTRU transmission power limits, or end-to-end latency requirements for executing the machine-type task. An inference method for the machine-type task may be determined based on the machine-task context information and the NW-related parameters. An indication of the inference method may be transmitted to at least one of the NW or a remote server. The indication may include at least one of a validity period or predicted network resource requirements for the inferencing method.

### BACKGROUND

Machine type communication (MTC) enables wireless interconnectivity among machines and devices without requiring human intervention, forming a network of connected devices. Examples of these devices may include sensors, actuators, and/or self-driving cars. Cellular networks, particularly 5G, may play a central role in facilitating these types of communications due to several factors. First, their ubiquitous presence may provide extensive coverage and mobility support. Additionally, certain features and configurations within the 5G protocol stack may support MTC applications. These features may include Flexible Numerology, flexible allocation of uplink and/or downlink resources, large bandwidth capabilities, and/or edge computing functionalities.

Edge-assisted navigation machine tasks may involve various machine-type sub-tasks. These sub-tasks may include object detection and/or classification, path planning and/or situational awareness, tracking and/or following a target vehicle, and/or precision localization and mapping.

### SUMMARY

A wireless transmit/receive unit (WTRU) may include a processor. The processor may be configured to determine machine-task context information for execution of a machine-type task. The machine-task context information may include at least one of application performance information, WTRU performance information, edge server performance information, or network (NW) performance information. NW-related parameters may be received, and may include at least one of channel bandwidth, WTRU transmission power limits, or end-to-end latency requirements for executing the machine-type task. An inference method for the machine-type task may be determined based on the machine-task context information and the NW-related parameters. An indication of the inference method may be transmitted to at least one of the NW or a remote server. The indication may include at least one of a validity period or predicted network resource requirements for the inferencing method.

The application performance information may include at least one of observed application round trip time, application round trip time thresholds, or data size related to the machine-type tasks.

The WTRU performance information may include at least one of compute delay or computation load related to the execution of the machine-type tasks.

The edge server performance information may include at least one of compute delay or computation load related to the execution of the machine-type tasks.

The NW performance information may include at least one of transport layer congestion, packet drops, or buffer status related to the execution of the machine-type tasks.

The NW-related parameters may include at least one of allocated bandwidth, NW backhaul latency, or packet drops.

The processor may be configured to determine the validity period of the inference method based on at least one of a number of slots, frames, or milliseconds for which the local, remote, or split inferencing method is determined to be valid.

The processor may be configured to determine the inference method based on at least one of machine-task quality of service (QoS) requirements, a WTRU environment, or a wireless channel condition. The inference method may include local inferencing, remote inferencing, or split inferencing.

The WTRU environment may include at least one of a WTRU location, a number of objects near the WTRU, characteristics of the objects near the WTRU, or atmospheric conditions that affect machine-task application performance. The wireless channel condition may include at least one of a channel quality indicator (CQ), a reference signal received power (RSRP), or a path loss.

The indication of the inference method may include at least one of predicted bandwidth requirements, throughput, or expected round-trip time for executing the inference method.

Methods implemented by a wireless transmit/receive unit (WTRU) may be described herein. The method may include determining machine-task context information for execution of a machine-type task. The machine-task context information may include at least one of application performance information, WTRU performance information, edge server performance information, or network (NW) performance information. NW-related parameters may be received, and may include at least one of channel bandwidth, WTRU transmission power limits, or end-to-end latency requirements for executing the machine-type task. An inference method for the machine-type task may be determined based on the machine-task context information and the NW-related parameters. An indication of the inference method may be transmitted to at least one of the NW or a remote server. The indication may include at least one of a validity period or predicted network resource requirements for the inferencing method.

The application performance information may include at least one of observed application round trip time, application round trip time thresholds, or data size related to the machine-type tasks.

The WTRU performance information may include at least one of compute delay or computation load related to the execution of the machine-type tasks.

The edge server performance information may include at least one of compute delay or computation load related to the execution of the machine-type tasks.

The NW performance information may include at least one of transport layer congestion, packet drops, or buffer status related to the execution of the machine-type tasks.

The NW-related parameters may include at least one of allocated bandwidth, NW backhaul latency, or packet drops.

The method may include determining the inference method based on at least one of machine-task quality of service (QoS) requirements, a WTRU environment, or a wireless channel condition. The inference method may include local inferencing, remote inferencing, or split inferencing.

The WTRU environment may include at least one of a WTRU location, a number of objects near the WTRU, characteristics of the objects near the WTRU, or atmospheric conditions that affect machine-task application performance. The wireless channel condition may include at least one of a channel quality indicator (CQ), a reference signal received power (RSRP), or a path loss.

The indication of the inference method may include at least one of predicted bandwidth requirements, throughput, or expected round-trip time for executing the inference method.

The WTRU may engage in data communication with the network to facilitate edge server-assisted machine-type tasks and machine-type communication. Leveraging Artificial Intelligence/Machine Learning (AI/ML) and context-aware adaptive split inferencing, the WTRU may enable adaptive split inferencing and machine-task offloading for emerging machine-type applications, such as connected vehicles. This may be based on the context of the WTRU, network, and machine-task server.

The WTRU may gather data regarding application configuration, machine-task server performance, upper network layer configuration, WTRU capabilities, and environmental conditions to generate context specific to the WTRU.

The WTRU may receive lower network layer configurations and estimated channel conditions to generate network context. Using both network and WTRU-generated context, the WTRU may determine an optimal split-inferencing and machine-task offloading method that adapts to dynamic network conditions, computational capabilities, and power constraints.

The WTRU may ensure that the machine-task Quality of Service (QoS) meets dynamic, event-driven thresholds, while conserving spectrum, computational resources, and energy.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example edge/remote assisted machine type task.

FIG. 3 is a diagram illustrating an example edge/remote assisted machine type task workflow.

FIG. 4 is a diagram illustrating three different example computing paradigms or approaches, including Local Computing (LC), Split Computing (SC), and Edge Computing (EC).

FIG. 5 is a diagram illustrating an example conceptual model for split computing in resource constrained environments.

FIG. 6 is a diagram illustrating an example time domain resource assignment from NW to UE in 5G NR.

FIG. 7 is a diagram illustrating an example of dynamic and configured scheduling in 5G NR.

FIG. 8 is a diagram illustrating an example frequency domain resource assignment for UEs in 5G NR.

FIG. 9 is a diagram illustrating an example 5G NR PHY frame structure with 30 kHz sub-carrier spacing.

FIG. 10 is a diagram illustrating an example uplink transmission process in 5G NR PHY TDD configuration with 30 kHz SCS.

FIG. 11 is a diagram illustrating an example 5G-NR PHY layer latency in TDD with 30 kHz SCS and 7DL, 2UL, 1F frame configuration.

FIG. 12 is a diagram illustrating an example use case of edge-based object classification and car license-plate identification for intelligent surveillance.

FIG. 13 is a diagram illustrating an example depicting the priority of a video frame based on the machine-type task.

FIG. 14 is a diagram illustrating an example scenario for estimating the threshold of round-trip time of video frame generation to inference feedback reception from remote server for machine-type task.

FIG. 15 is a diagram illustrating an example scenario for estimating the threshold of round-trip time of video frame generation to inference feedback reception from remote server for machine-type task.

FIG. 16 is a diagram illustrating an example scenario showcasing the dynamic nature of the QoS (round trip time threshold) for machine-type application, that depends on the UE environment characteristics.

FIG. 17 is a diagram illustrating an example of a vehicle equipped with sensors, capable of performing multiple tasks, and an edge server for AI/ML inference for decision-making for machine-type applications.

FIG. 18 is a diagram illustrating an example method for real-time object detection using a CNN on an edge device (e.g., local inference).

FIG. 19 is a diagram illustrating an example object detection system using remote processing (e.g., full offloading) using an edge device and an edge server.

FIG. 20 is a diagram illustrating an example distributed machine-task inference system (e.g., for object detection), that may utilize both an edge device and an edge server.

FIG. 21 is a diagram illustrating an example instance of an AIML model split at a particular time instance.

FIG. 22 is a diagram illustrating an example method for UE context aware adaptive local/remote/split inferencing for multiple active machine-type tasks.

FIGS. 23A and 23B are diagrams illustrating an example of context-aware adaptive inferencing procedure that can be performed by a WTRU for multiple active machine-task applications.

### DETAILED DESCRIPTION

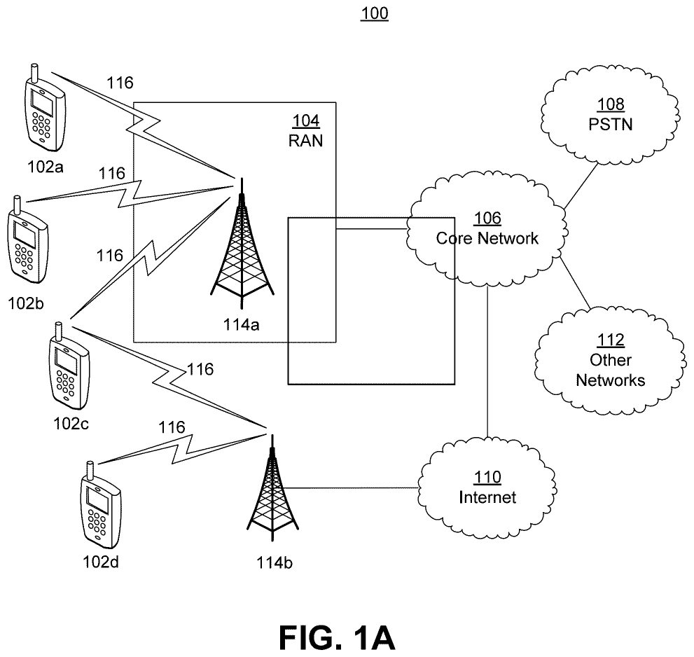

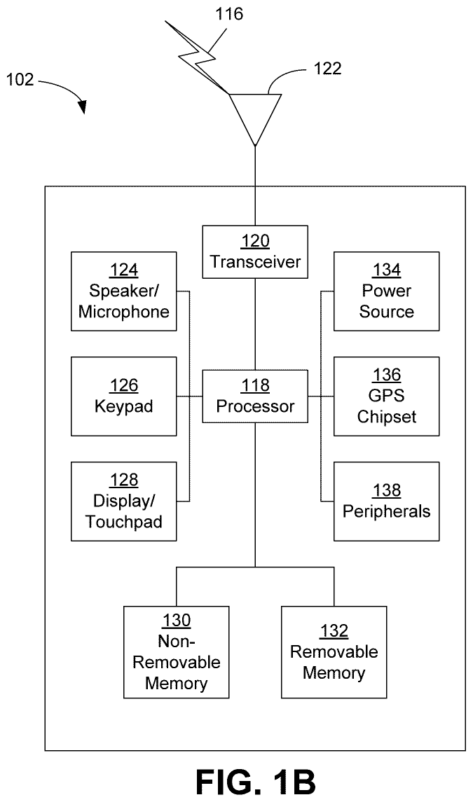

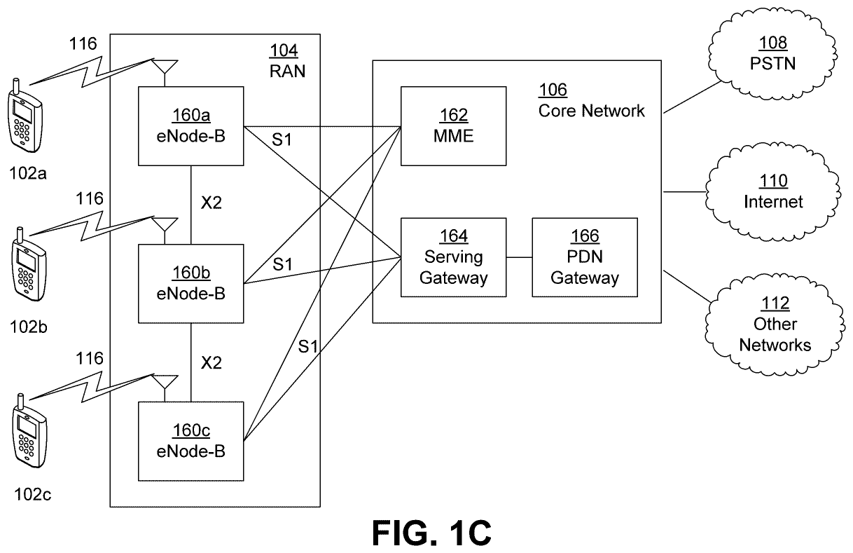

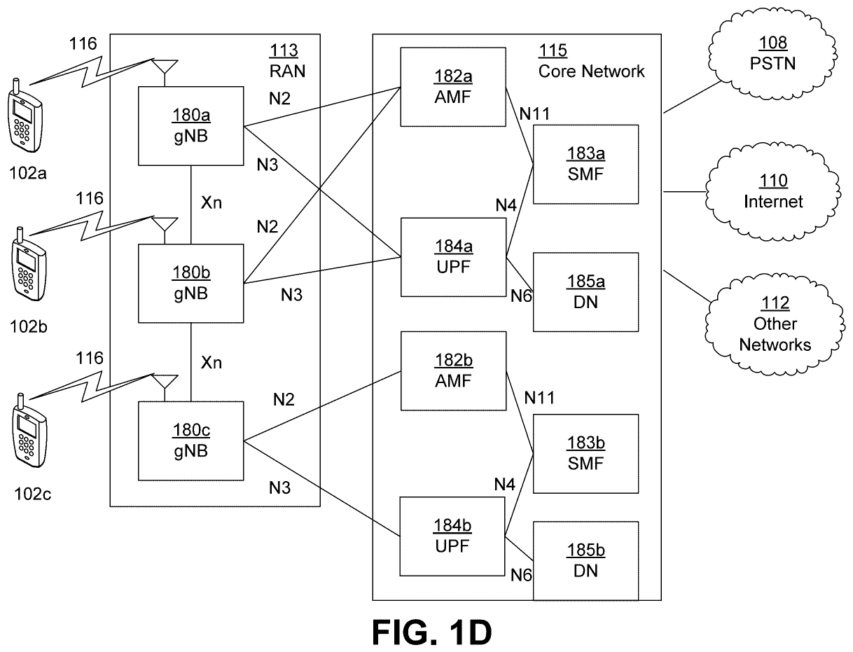

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and/or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

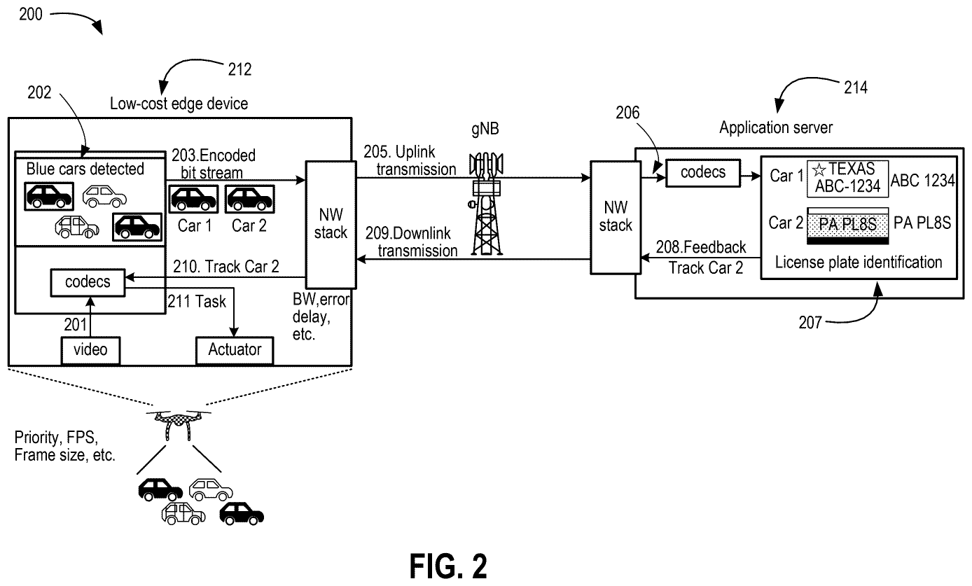

FIG. 2 is a diagram 200 showing an example edge and/or remote assisted machine type task. For edge-assisted smart surveillance, a multi-modal sensor-enabled connected smart device (e.g., drone, vehicle, and/or similar device) or WTRU may monitor an area of interest using its sensors (e.g., video camera, lidar, and/or other sensing technologies). The machine task in this example scenario may involve monitoring the area for cars that match a specified license plate number and following the car once it has been identified. The connected WTRU may receive assistance from an edge server over a next-generation network (NW) to execute security-sensitive and compute-intensive processes of smart surveillance (e.g., license plate identification) after receiving the sensed data inputs from the WTRU. The process may be executed through a multi-step approach as shown in FIG. 2. At 201, the WTRU may capture events in its surroundings through its sensors, generating data (e.g., video frames) that a local AI/ML application on the device may use to perform the initial part of the machine task (e.g., object detection and/or classification). If certain object detection or classification thresholds are met (e.g., a high confidence threshold for blue cars detected) at 202, then the corresponding application data containing the detected blue car(s) may be encoded into bitstreams at 203. The encoded bitstreams may be carried over the NW stack at 204 and transmitted as an uplink transmission to the NW via the gNB at 205. At 206, the NW may forward the data to the application server, where application codecs decode the data and perform the subsequent AI/ML machine tasks at 207 (e.g., license plate identification) on the decoded data.

Based on the inference results and performance metrics (e.g., a high confidence level of positive license plate data identification), the application server may generate proper machine-task feedback (e.g., instructions to track and follow a car with a specific license plate) at 208 and encode this feedback data. At 209, the encoded feedback data may be transmitted over the NW to the smart device as a downlink transmission. The WTRU may extract the machine-task information from the feedback data at 210, followed by executing necessary AI/ML tasks (e.g., object tracking) and initiating device actuator functions at 211 (e.g., adjusting speed, direction, and/or other parameters) to follow the target vehicle.

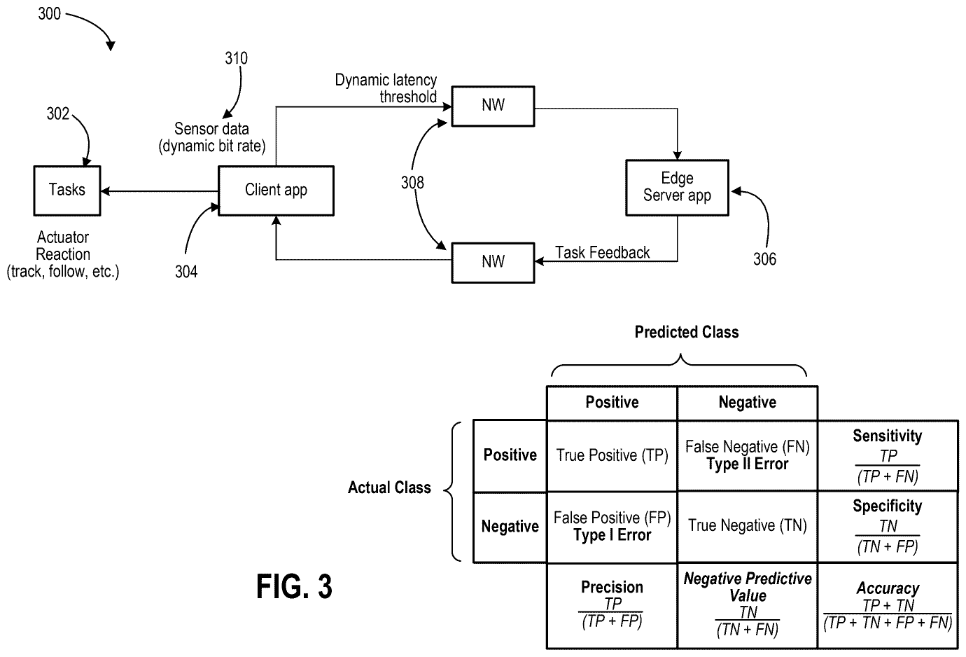

FIG. 3 is a diagram 300 illustrating an example edge/remote assisted machine type task workflow. An edge-assisted task 302 may be generalized as a client application 304 running on an autonomous entity or WTRU (e.g., vehicles, cars, unmanned aerial vehicles, and/or unmanned ground vehicles) that may offload sensor data 310 to edge servers via the network. This setup allows the edge servers to conduct compute-intensive AI/ML-based inference tasks, such as object detection, classification, and/or tracking. The edge server 306 may provide inference decision feedback to the client application 304 via the network 308 in a timely manner, enabling the client application 304 to generate actions for the autonomous entity based on this inference result (e.g., identifying an object classified as a car detected at a specific distance and heading in a particular direction). This inference may prompt the client application to initiate actions for the autonomous entity (e.g., adjusting speed and/or direction to avoid collision). Some performance indicators for machine-type applications may be characterized by the round trip time (sensor data generation to inference feedback reception), throughput, and/or other metrics. These indicators may depend on the type of task (e.g., object detection, which requires lower data transmission rates per unit of time compared to object classification and tracking), the WTRU environment (e.g., the number of objects around the WTRU, object behaviors such as static or mobile, and/or atmospheric conditions), and/or the WTRU's own behavior (e.g., mobility and direction).

There are several differences between human-type applications and machine-type applications in this context. The network demands of legacy human-type communications, such as those required by applications such as video streaming, may differ fundamentally from those of machine-type communications (MTC), such as edge-assisted object detection and tracking for mobile vehicles. Understanding these differences may be particularly useful for designing and optimizing 5G networks that effectively support both communication categories effectively.

Human-type communications have traditionally dominated network traffic, with video streaming representing one of the most bandwidth-intensive applications. The quality of service (QoS) in this context may be measured in terms of video resolution, frame rate, and buffering times, emphasizing minimizing delays and interruptions. Modern video streaming technologies can adapt to varying network conditions by dynamically adjusting the video quality (e.g., by reducing resolution and/or bitrate). Existing buffering techniques and adaptive streaming protocols help mitigate latency issues, ensuring a smooth playback experience even over fluctuating network conditions. Each video frame may contribute equally to the overall viewing experience. Loss or corruption of even a comparatively small portion of the data (e.g., a few frames) may degrade perceived quality, leading to interruptions or pixelation. Consequently, packet loss and jitter may be particularly important parameters that impact the quality of video delivery. The traffic generated by video streaming may generally be asymmetric, with a higher volume of data flowing from the server to the client (e.g., downlink).

In contrast, emerging machine-type applications (MTC) applications, such as edge-assisted object detection and tracking for autonomous vehicles and mobile vehicles, present distinct network demands. These applications may generate substantial uplink traffic as raw sensor data information, including images and videos. This data may be transmitted from vehicles to edge servers for processing. The processed data information, although less voluminous, may then be sent back to the vehicles so that the vehicles can undertake follow-on actions. Real-time object detection and tracking may require near-instantaneous data transmission and processing to enable timely decision-making and action by mobile vehicles. Thus, the utility of data in MTC may be closely tied to its timeliness, since delayed data may render even high-utility information obsolete, particularly in dynamic environments.

In MTC, certain data segments may have comparatively higher priority, such as data capturing an object in the vehicle's path, which is crucial for navigation and collision avoidance. The traffic patterns for MTC applications may exhibit high variability and bursts, driven by the episodic nature of sensing and control operations. In real-world examples, MTC data may be event-driven, with the importance of data spiking during critical events, such as obstacle detection. Not all data generated by sensors is of equal importance, as data related to significant environmental changes may have higher utility than static or redundant information. Efficient data prioritization and compression techniques may be needed to ensure that the most relevant data is transmitted and processed first. Therefore, unlike video streaming, MTC applications may involve event-based data prioritization and stringent latency requirements, as these metrics may significantly impact the functionality and safety of autonomous vehicles and robotic operations.

There may be various challenges for Machine-Type Communication (MTC) use cases for edge-assisted navigation. For example, End-to-end (E2E) latency may be affected by application server performance, which remains outside network control. During the execution of an edge-assisted machine task, the application server's status may vary, shifting from available and lightly loaded to heavily loaded or even unavailable. This variability may impact edge inference quality and timeliness, which in turn can impact the application round-trip time and ultimately the machine task performance of the machine task. For example, in the case of smart surveillance, a delay in feedback could cause a missed opportunity to track and follow a car, as it may have moved out of the smart device's field of view by the time feedback is received.

An application's communication requirements may vary over time based on different application-specific machine tasks and situations. For example, in an edge-assisted use-case of smart surveillance use case, there may be different numbers of objects with diverse behaviors (e.g., cars moving at varying speeds and remaining in the smart device field of view for varying amount of time) in the area to be surveilled at different time instances, leading to different amounts of data generated by the application and transmitted to the edge-server to run edge inference on. This type of event-based application task requirement can have a direct impact on the application round trip time latency and network bandwidth requirements, which can be very dynamic and unpredictable.

Quality of Service (QoS) requirements for the same application may have different QoS requirements based on different user behaviors. In the example of edge-assisted smart surveillance of an area of interest, the objects of interest (e.g., cars) can have varying speeds, with some drivers demonstrating cautious or safe behavior while others may demonstrate aggressive or unsafe behavior. This user behavior affects how long these objects stay within the smart device's field of view. Sensor data captured when an object appears in the field of view must be sent to the edge server for processing, and the edge inference feedback must reach the smart device before the object leaves the field of view. Unpredictable user behavior thus impacts the bandwidth and latency requirements for the machine task. This user behavior may determine how long the objects of interest will stay within the field of view of the smart device that is performing the surveillance. The data captured by the sensors when the object of interest appears in the field of view, needs to be transmitted to the edge server for edge inference and the edge inference feedback needs to reach the smart device before the object of interest leaves the field of view of the sensors on the smart device. The unpredictable user behavior thus may determine the bandwidth and latency requirement of the application executing the machine type task. The cautious or safe driving instances may require moderate latency and bandwidth requirement, whereas the aggressive or unsafe driving instances may generate critical bandwidth and latency requirements.

Legacy 5G New Radio (NR) maintains application QoS through optimizations within each layer of the network (NW) stack, some of which may be controlled by the NW (e.g., MAC, PHY) while some may be controlled by the WTRU (e.g., RLC, transport layer, and/or application layer). The 5G compatible devices and the NW may follow the 3GPP standard for identifying an application as belonging to a specific class, based on fixed use-cases given in 3GPP TS 23.501, which determine the application's fixed QoS bounds. The NW follows some pre-defined use cases. The network then follows set rules within each of the NW layers to maintain the fixed QoS bounds of the application in the NW. These metrics may not consider the MTC applications characterized by event-based traffic with varying QoS bounds and do not consider the impact of the performance of the entities that are not under the control of the network control, such as user behavior and environmental factors that influence the QoS bounds of MTC. Some of the standard 3GPP procedures in the NW layers that are under NW control (e.g., MAC, PHY) and the NW layers that are under WTRU control, that impact the application QoS, are described further detail herein below.

The rise of demanding mobile applications, such as real-time drone navigation and obstacle avoidance, necessitates the execution of complex inference tasks on resource-constrained devices. State-of-the-art AI/ML models may possess computational requirements that far exceed the capabilities of mobile platforms. Current approaches address this challenge through model complexity reduction techniques, such as knowledge distillation and pruning/quantization, or by designing lightweight AI/ML models. While these methods effectively reduce computational overhead, often significant accuracy degradation. Edge computing offers an alternative approach by offloading the computational burden entirely to edge servers. However, even in scenarios with high-throughput wireless links, fluctuations in channel quality can significantly impact edge-server based inference performance. Environmental factors, mobility, and signal propagation impairments can introduce unpredictable capacity variations, even in high bandwidth 5G networks, limiting the benefits of edge computing.

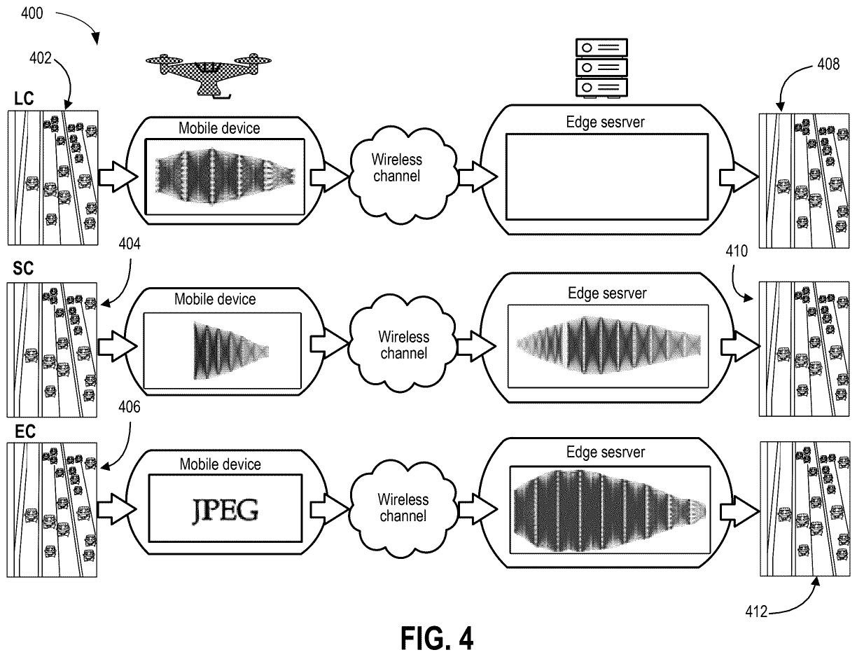

FIG. 4 is a diagram 400 illustrating three different example computing paradigms or approaches, including Local Computing (LC), Split Computing (SC), and Edge Computing (EC), in the context of machine learning applications for connected vehicles. For ease of illustration, a drone is utilized to represent the connected vehicle in this example, but it is to be appreciated that any sort of connected vehicle may be utilized in various examples. The drone may capture images which may be then processed using one or more of the LC, SC, and/or EC paradigms or approaches.

For LC 402, the entire machine learning model may be deployed and executed directly on the mobile device (e.g., a drone). Raw image data may be processed locally on the device, allowing inference results (e.g., object detection and/or traffic analysis) to be generated on-site. The advantages of LC may include low latency since no data transmission is required, making it suitable for applications where immediate decisions are essential. Additionally, LC may preserve data privacy, as information remains on the device without external transmission. However, LC may have high computational demands, potentially causing faster battery depletion. It is limited by the mobile device's processing power and storage and may not be suitable for more complex models.

SC 404 may involve dividing the machine learning model into two parts. Initial layers may be executed on the mobile device to extract features from raw images. These intermediate features may then be transmitted wirelessly to the edge server, where the model's remaining layers complete the inference. This approach may reduce the computational load on the mobile device, extending battery life, and leveraging the edge server's powerful resources to handle complex models. However, SC may depend on network connectivity and bandwidth, introducing latency due to data transmission and raising potential privacy concerns since intermediate features are sent to the server.

In EC 406, the raw image data may be compressed (e.g., using JPEG) on the mobile device before transmission to the edge server, where the complete machine learning model may be deployed. The edge server may perform the inference on the compressed image. EC may significantly reduce the data transmission size, making it suitable for bandwidth-constrained environments while offloading computation to the edge server. However, compression may result in some data loss, which could affect model accuracy. This approach may also depend on network connectivity and may introduce latency due to transmission and decompression.

Each of these computing paradigms may offer trade-offs between latency, computational efficiency, and data privacy in connected vehicle applications and output 408, 410, and 412. LC may be ideal for real-time, critical tasks on powerful drones or vehicles that require immediate decisions (e.g., obstacle avoidance). SC may suit tasks that need more complex models while balancing computational load and latency, such as detailed scene analysis. EC may be appropriate when bandwidth is limited or for tasks where minor accuracy loss is tolerable (e.g., uploading images for later analysis in the cloud). The selection of a computing paradigm may depend on specific application requirements, the available resources on the vehicle, and network infrastructure.

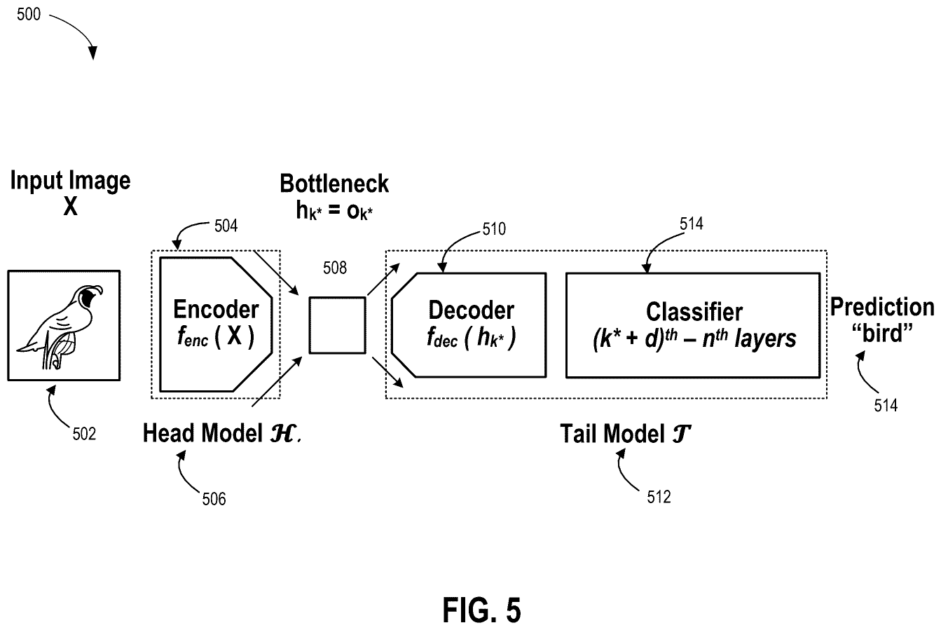

FIG. 5 is a diagram 500 illustrating an example conceptual model for split computing, a technique which may be utilized to optimize machine learning inference, especially in resource-constrained environments like mobile devices or edge computing scenarios. Split computing may involve dividing a large model into two parts, referred to as the Head Model and the Tail Model, to effectively distribute the computational load.

In examples, elements in the model may include an input image (X) 502, representing the raw data fed into the model, which in this example case, is an image of a bird. The Encoder 504 (fenc(x)) component may be a part of the Head Model 506, may process the input image and may transform it into a compact, high-level representation called the “bottleneck” (hk*) 508, which may extract features and/or information determined to be the most essential from the image. This bottleneck may be an intermediate representation generated by the encoder, and may be a compressed version of the input data that captures its key characteristics. The Decoder (f_{dec} (h_{k*}) 510 may be located within the Tail Model 512, receives the bottleneck representation and may reconstruct the original input or generate a related output. In the context of split computing, the Decoder may further process the extracted features for the specific task at hand. The Classifier 514, also within the Tail Model, may take the output of the Decoder and perform the final classification task, utilizing layers from (k*+d)th to the nth and leveraging deeper layers of the model. The final output 516 of the model (e.g., prediction), in this example, may classify the input image as a “bird.” The Head Model (H) may encompass the Encoder and may be deployed on the resource-constrained device (e.g., a mobile phone). The Tail Model (T) may include the Decoder and Classifier and may be deployed on a more powerful server or cloud infrastructure.

In split computing with bottleneck insertion, the device itself may perform the computationally intensive initial feature extraction (e.g., Encoder) on the device itself, thus reducing the amount of data that needs to be transmitted over the network. The compact bottleneck representation is then sent to the server, where the remaining computations (e.g., Decoder and Classifier) may be completed. This approach reduces communication overhead, as only the bottleneck representation may need to be transmitted, thereby saving bandwidth. It allows for efficient resource utilization by leveraging the computational capabilities of both the device and the server, and offloading heavy computation may enable faster response times on the device, making the approach suitable for real-time applications. However, challenges with this method may include designing an effective bottleneck that captures sufficient information for accurate inference while remaining compact, balancing the split of the model between the Head and Tail Models to optimize energy, compute, and network resource utilization for inference accuracy, and the network dependency, as this method relies on a stable connection for transmitting the bottleneck. The encoding may be represented by:

$$ℋ = {f}_{enc} = \{ \begin{matrix}{h}_{0} = {o}_{0} = x & \\ {h}_{j} = {f}_{j} ( {o}_{j - 1} , {θ}_{j} ) & 1 \leq j \leq {k}^{*} - 1 \\ {h}_{k *} = ℬ ( {o}_{k * - 1} , {θ}_{ℬ} ) & \end{matrix}$$

where [symbol] is the set of parameters of the bottleneck layer [symbol] , and h_{k*} indicates the bottleneck representation to be transferred from the mobile device to the edge server in an inference session.

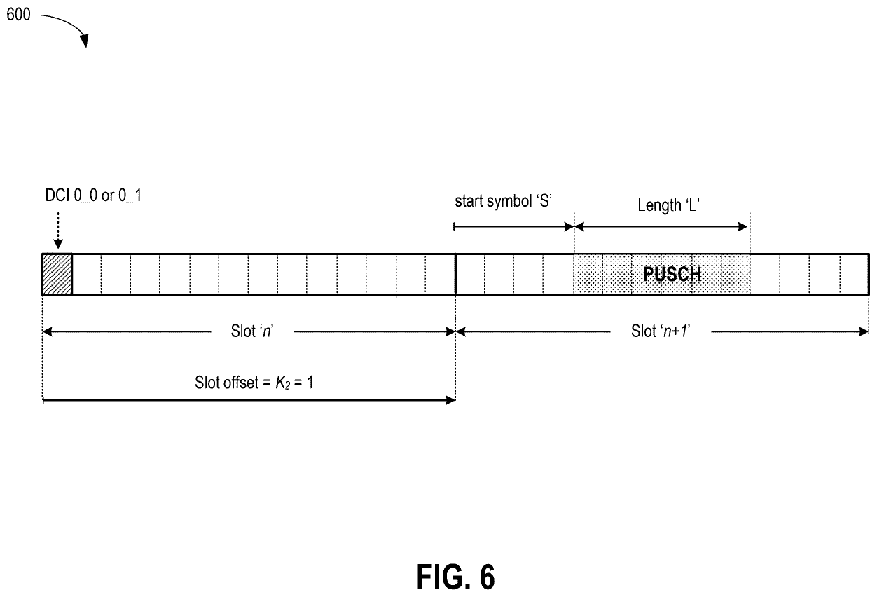

FIG. 6 is a diagram 600 illustrating an example time-domain resource assignment from the NW to the WTRU in 5G NR. In 5G NR, not all start and length values may be valid, as a single time-domain resource allocation may not extend across a slot boundary. The number of symbols in each slot may vary based on the cyclic prefix (CP), which may limit the allowed start and length combinations. For normal CP, a slot may contain 14 OFDM symbols, while for extended CP, each slot may contain 12 OFDM symbols.

In 5G NR, the NW may inform the WTRU regarding which slots and/or symbols the data can be transmitted and/or received through signaling of time-domain resources either dynamically or in semi-persistent manner. Dynamic scheduling in the uplink may be performed using PDCCH DCI. For semi-persistent scheduling, NR defines two mechanisms, with one using PDCCH DCI and the other one using RRC signaling. In NR, DCI formats 0_0 and 0_1 may be used to dynamically allocate time-domain resources for PUSCH. DCI formats 0_0 and 0_1 carry a 4-bit field named ‘time domain resource assignment’ which points to one of the 16 rows of a look-up table.

Each row in the look-up table may provide parameters such as slot offset K₂. This parameter may be used to derive the slot in which PUSCH transmission occurs. Parameters may include jointly coded Start and Length Indicator Values (SLIV), or individual values for the start symbol “S” and allocation length “L”. Parameters may include a PUSCH mapping type' to be applied on the PUSCH transmission. FIG. 3 illustrates an example with time domain resource assignment field in DCI 0_0/0_1 indicating (e.g., based on look-up table) K2=1, S=4 and L=6 symbols.

There may be two types of PUSCH resource allocation tables (e.g., look-up tables) utilized. For example, a default PUSCH time domain allocation table, Table A, which may be a predefined table in TS 38.214 as Table 6.1.2.1.1-2 for normal CP and Table 6.1.2.1.1-3 for extended CP. A RRC configured table, known as PUSCH-TimeDomainAllocationList, which may be sent in either PUSCH-ConfigCommon (e.g., sent via SIB1 or dedicated RRC signaling) or PUSCH-Config (e.g., sent via dedicated RRC signaling). The WTRU may select the appropriate table based on several factors, such as which of the above tables is configured in the WTRU, the RNTI, and the search space type. Table selection criteria may be specified in Table 6.1.2.1.1-1 in TS 38.214.

In the PUSCH time-domain resource allocation list, the value of K2 may range from 0 to 32, unlike in default Table A, which allows for PUSCH transmission within the same slot where the allocation is received. When the K2 field is absent, the WTRU may apply a value 1 when PUSCH SCS is 15/30 kHz, the value 2 when PUSCH SCS is 60 kHz, and the value 3 when PUSCH SCS is 120 kHz.

For uplink semi-persistent scheduling (SPS), PDCCH carrying DCI 0_0 and 0_1 may be addressed to Configured Scheduling-RNTI (CS-RNTI). The grant received using CS-RNTI is referred to as configured grant/scheduling, which is given by the NW to WTRU, who stores the received grant and uses it according to the pre-configured timing given by the network.

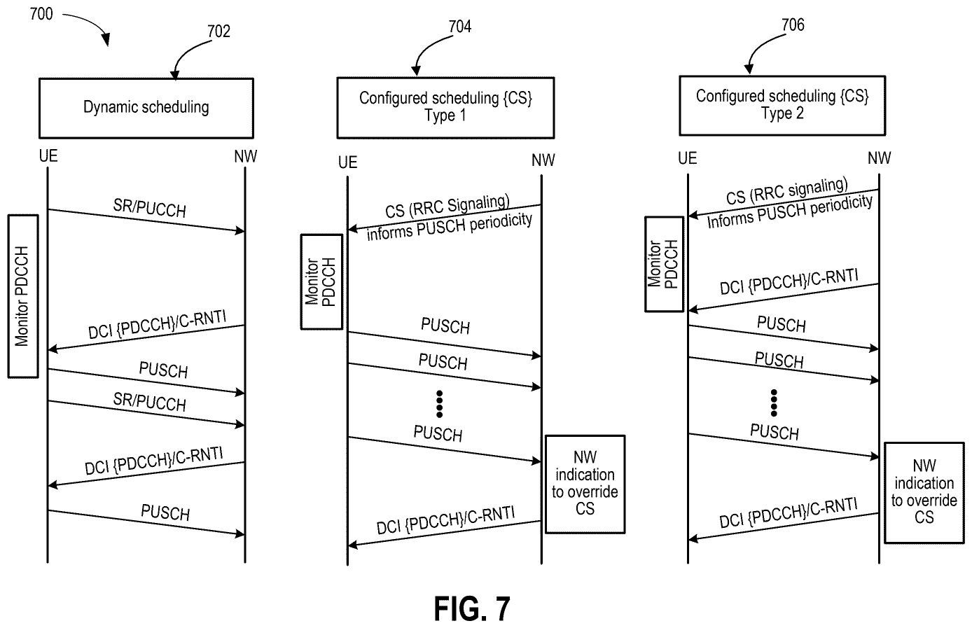

FIG. 7 is a diagram 700 showing an example of dynamic and configured scheduling in 5G NR. In configured grant Type 1, resource allocation may occur via RRC, and PDCCH DCI 0_0 or 0_1 addressed to CS-RNTI may be used only for retransmissions. In this type of resource allocation, once the NW configures the time-domain resource using RRC, the only way to modify the allocation may be by reconfiguring the parameters through an RRC Reconfiguration message sent to the WTRU. In configured grant Type 2, time-domain resource allocation may be managed using PDCCH DCI formats 0_0 or 0_1 addressed to CS-RNTI. Once configured, the WTRU may periodically use the same time-domain resources until the configured grant is reactivated, which may function as a reconfiguration at the MAC level.

In domain resource assignment in 5G NR (3GPP TS 38.214), for frequency domain resource allocation, the NW may inform the WTRU about the frequency resources to be used for the transmission of PUSCH using DCI formats 0_0, 0_1, or 0_2. Within these DCI Formats, the field ‘Frequency domain resource assignment’ may carry the required resource allocation, including information which informs the WTRU about resource blocks (RBs) and the corresponding bandwidth part (BWP) for intended data transmission or reception. Using the allocated frequency resources, the WTRU may transmit or receive data on PUSCH and/or PDSCH.

NR may support three types of uplink resource allocation schemes: type 0, type 1, and type 2. The uplink resource allocation scheme type 0 may be supported for PUSCH only when transform precoding is disabled. Uplink resource allocation schemes type 1 and type 2 may be supported for PUSCH when transform precoding is either enabled or disabled. The network may inform the WTRU which resource allocation scheme to use via RRC signaling, where PUSCH-Config IE may be used for dynamic resource allocations, and ConfiguredGrantConfig IE may be used for configured (e.g., semi-persistent) resource allocations.

In an example of Type 0 uplink resource allocation, the “Frequency domain resource assignment” field (e.g., a bitmap) within DCI formats 0_1 or 0_2 may indicate which Resource Block Groups (RBGs) are allocated to the WTRU. An RBG may be allocated to the WTRU if the corresponding bit value in the bitmap is 1; it may not be allocated if the bit value is 0. For instance, consider a configuration where there are two WTRUs, with WTRU1's resource allocation bitmap set as 10101010 and WTRU2's as 01010101, the starting RB of the BWP set as 5, and the BWP size as 32 RBs. FIG. 7 illustrates the specific RBs that may be allocated to WTRU1 and WTRU2 under configuration type 2.

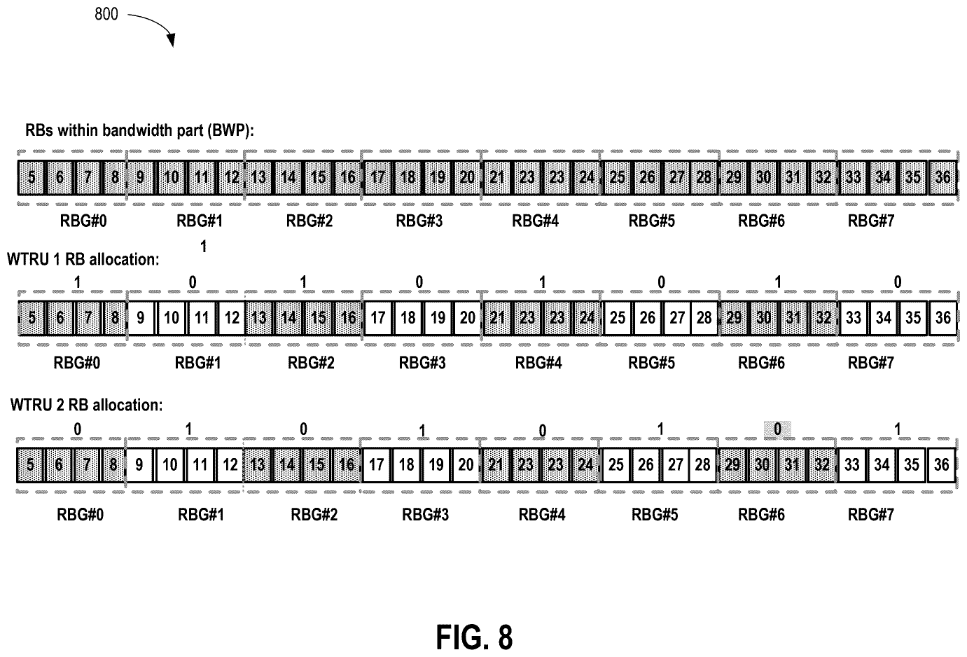

FIG. 8 is a diagram 800 illustrating an example frequency domain resource assignment for WTRUs in 5G NR. For frequency domain resource allocation in 5G NR, the network (NW) may inform the WTRU about the frequency resources to be used for PUSCH transmissions through DCI formats 0_0, 0_1, or 0_2. Within these formats, the “Frequency domain resource assignment” field may carry information about resource blocks (RBs) and the corresponding bandwidth part (BWP) used for transmitting or receiving data. Using this allocation, the WTRU may perform data transmission on PUSCH or data reception on PDSCH. NR supports three uplink resource allocation schemes: type 0 (702), type 1 (704), and type 2 (706). Type 0, however, may only apply to PUSCH when transform precoding is disabled, while types 1 and 2 may support PUSCH whether transform precoding is enabled or disabled. The NW may inform the WTRU of the applicable scheme via RRC signaling, with PUSCH-Config IE used for dynamic allocations and ConfiguredGrantConfig IE for configured (e.g., semi-persistent) allocations.

In an example for Type 0 uplink allocation, the “Frequency domain resource assignment” field may use a bitmap within DCI formats 0_1 or 0_2 to indicate which Resource Block Groups (RBGs) are allocated to the WTRU. Each bit in the bitmap may determine if an RBG is allocated, with a bit value of 1 indicating allocation and 0 indicating no allocation. For instance, if WTRU1's resource allocation bitmap is set as 10101010 and WTRU2's as 01010101, with a BWP start RB at 5 and a BWP size of 32 RBs, FIG. 7 illustrates which RBs may be allocated to WTRU1 and WTRU2.

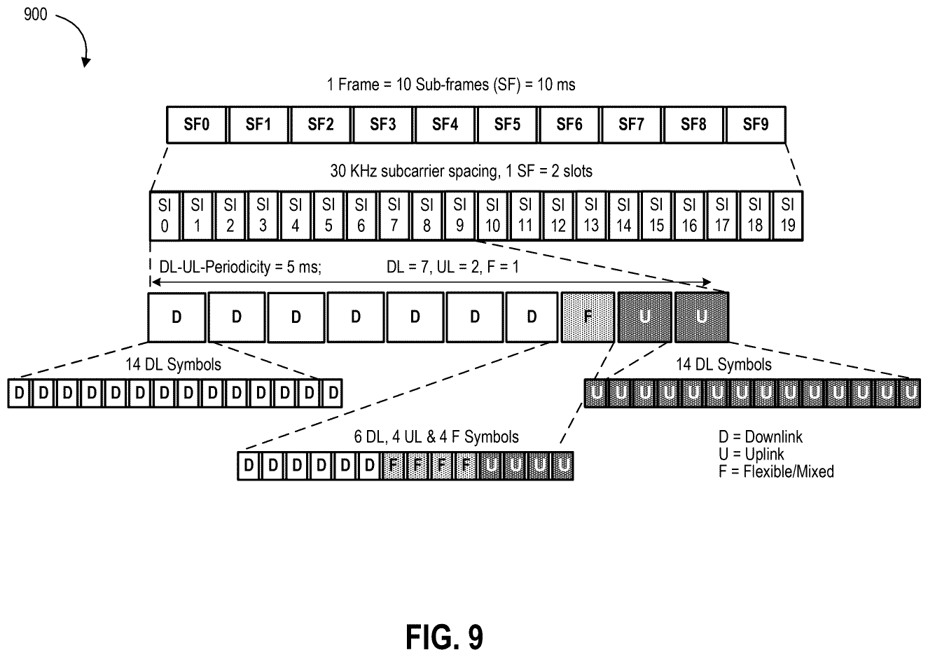

FIG. 9 is a diagram 900 illustrating a 5G NR PHY frame structure with 30 kHz sub-carrier spacing (SCS). In 5G NR, a frame may be 10 ms long and divided into 10 subframes, with the number of slots in each subframe depending on the numerology, while the number of slots in a subframe varies. For PHY Layer latency in 5G NR (3GPP TS 38.214) the NW may divide the operational bandwidth into time slots where some slots are for downlink (DL), some are for uplink (UL), and/or some are flexible use slots (e.g., either DL or UL). This time-division resource allocation method, known as Time-Division Duplexing (TDD), manages both downlink and uplink transmissions efficiently.

For example, a subframe with 30 kHz SCS may contain two slots. In TDD, DL-UL periodicity determines the allocation of consecutive DL and UL slots. Each slot may be further divided into symbols, with FIG. 8A showing an example uplink transmission process in TDD. Here, a WTRU may send a scheduling request (SR) to the NW in a flexible slot (F) to indicate that it has data to send. The NW then schedules the next available UL slot for data transmission, based on the request.

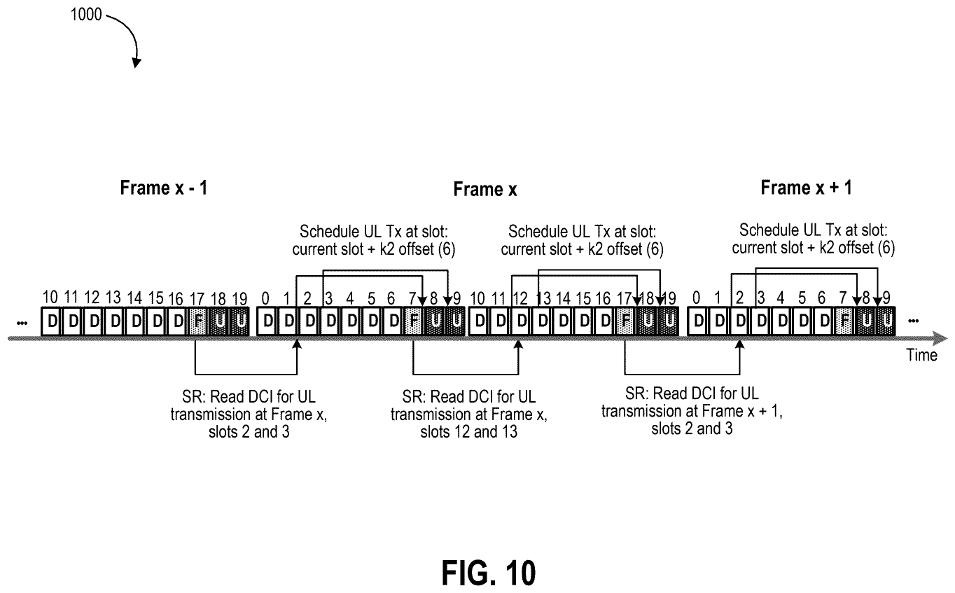

A frame in 5G NR may be 10 ms long, which may be broken down into 10 subframes. Depending on the numerology, the number of slots in a subframe may vary. In this example, a subframe with 30 KHz subcarrier spacing (SCS) has two slots. In TDD, the DL-UL-periodicity may determine the time for which there can be a consecutive set of downlink and uplink slots. Each slot may be further broken down into symbols. The uplink transmission methodology in TDD is illustrated by example in FIGS. 9 and 10. First, in a flexible (F) slot, the WTRU may send a scheduling request (SR) to the NW indicating that it has some data to send. The NW, in the next DL DCI slot, which could be in the same frame or the next one, may schedule the next UL slot for the WTRU to send the data finally.

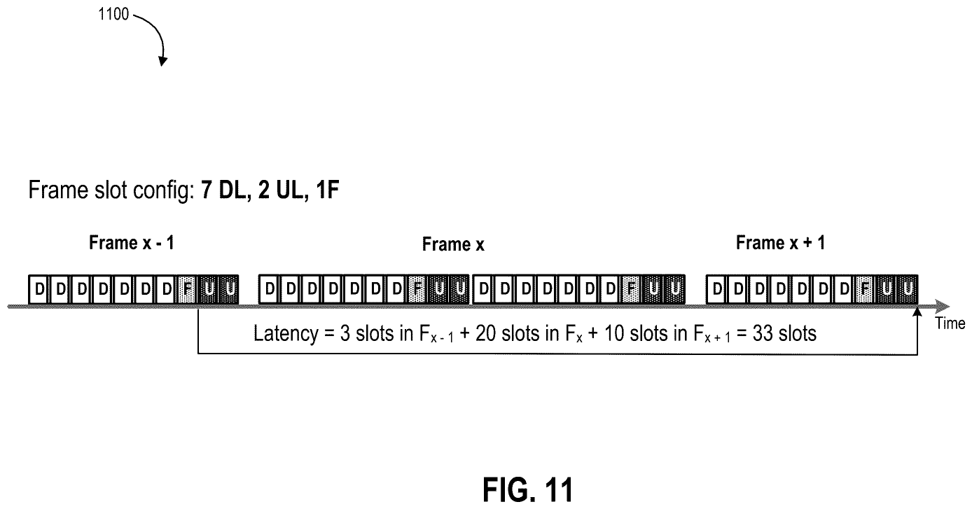

FIG. 10 is a diagram 1000 illustrating an example of PHY layer latency in TDD, using a configuration with 7 DL slots, 2 UL slots, and 1 flexible slot. FIG. 11 is a diagram 1100 illustrating an example 5G-NR PHY layer latency in TDD with 30 KHz SCS and 7DL, 2UL, 1F frame configuration.

FIGS. 10 and 11 illustrate an example of quantifying the PHY layer needed to upload data from a WTRU to a NW. For example, if 6 UL slots are needed to complete an uplink-intensive task, then based on a configuration that allows 7 DL (D) slots, 2 UL (U) slots and 1 flexible (F) slot, it may take 33 slots to finish the UL task. The PHY latency for UL may be calculated as the time difference between when the last UL data was sent in a particular slot in a frame and the time at which the first SR for the UL data was sent to the NW. In this example, the PHY latency is the time equivalent of 33 slots.

For MAC layer latency, the MAC scheduler at each base station (gNB) may decide on the WTRU-wise PRB allocation for each slot. In Frequency Division Duplexing (FDD), both PDSCH and PUSCH allocations are output per slot, while in TDD, the appropriate allocation (e.g., PDSCH for DL or PUSCH for UL) may occur in each DL or UL slot.

The scheduler may use one or more inputs for each gNB and attached WTRU. The inputs can include a number of MIMO layers. For DL, inputs can include PDSCH SINR at each layer, CQ at each layer, and/or MCS at each layer. For UL, inputs can include PUSCH SINR at each layer, CQ at each layer, and/or MCS at each layer. Inputs may include DL and UL buffer statuses, which may include buffer fill levels and traffic types (e.g., GBR and/or Non-GBR); and DL and UL HARQ contexts, including RV, HARQ-ID, and/or NDI. The scheduler may use the number of PRBs available in the gNB, prioritizing retransmissions over initial transmissions.

Several baseline MAC scheduling algorithms may be available, including Round Robin, Proportional Fair, and/or Max Throughput. The Round Robin scheduler may divide PRBs among active flows, while the Proportional Fair (PF) scheduler may schedule a user when its instantaneous channel quality is high relative to its average condition, thus maximizing throughput while maintaining fairness. The Max Throughput scheduler may prioritize active flows that achieve the highest CQI values. The scheduler's output determines WTRU-specific PRB allocations in both UL and DL for every slot.

In examples, packets may flow through the 5G stack to the RLC buffer, where they may start accumulating, as the wireless link often becomes the slowest link in the data path. Packets wait at the RLC sublayer until the MAC scheduler pulls a specific number of bytes for transmission. Each WTRU has at least one DRB, with up to 30 DRBs possible, creating multiple RLC buffers. These buffers form parallel queues, and the MAC scheduler may map resources to the RLC buffers following scheduling policies such as round-robin.

RLC buffers are FIFO queues, which restricts arbitrary packet pulling. The resource allocation, performed via RBGs instead of bytes, depends on MCS values, which dynamically change according to radio link conditions. Each WTRU delivers a channel quality estimation through the CQ, which determines the MCS. The MCS then defines modulation to use (e.g., BPSK, QPSK, 16 QAM, 64 QAM or 256 QAM that transmit 1, 2, 4, 6 or 8 bits per symbol, respectively) and coding rate, and thus, the channel capacity may be determined by the radio conditions. Higher-quality channels allow for the transmission of larger amounts of information.

There may be several different modes in which a RLC entity can be instantiated, including Transmission Mode (TM), Unacknowledged Mode (UM), and Acknowledged Mode (AM). Through a TM entity, only control information can be forwarded, while data information can flow by either a UM or AM entity. Both UM and AM share the ability to segment a packet if the TBS notified by the MAC does not fit within the size of the packets waiting.

The RLC sublayer may be segmented if the RLC SDU size is larger than the bytes requested by the MAC sublayer. Once packets are segmented and an RLC header is added, they may be transmitted to the receiver's RLC, where after removing the RLC header, they wait for a SDU reassembly before submitting them to the next sublayer (e.g., WTRU's PDCP in the downlink procedure). Therefore, information may not be forwarded until a complete reassembly occurs, which in the best case will occur in the next TTI. The segmentation and reassembly procedure may guarantee a full frequency spectrum utilization when the next packet size exceeds TBS. For example, a 5 MHz bandwidth LTE base station in ideal conditions may transmit approximately 2289 bytes per TTI. Since maximum packet sizes in IP network will use the maximum allowable packets size (e.g., 1500 bytes in Ethernet) to minimize the protocol's overhead and maximize the transmitted information ratio. This example shows that even ignoring the dynamic radio link channel's capacity (e.g., assuming a static TBS of 2289 bytes), a myriad of fragmented packets at the RLC sublayer may be generated as the TBS notified by the MAC would rarely coincide with the packets' size, and consequently, the delay may be increased.

Some constraints that may be considered in the RLC segmentation/reassembly procedure include the FIFO queue structure of RLC buffers, where packets are not pulled arbitrarily. Resource allocation may be performed through RBG, rather than bytes. The MCS may determine the channel capacity, which may dynamically change according to the radio link conditions.

For emerging machine-type communications (MTC), such as in Connected Vehicles (CV), etc., to maintain the necessary machine-task Quality of Service (QoS), the core tasks have stringent low-latency deadlines, and these deadlines may be dynamic for MTC because MTC traffic can be primarily event driven with dynamic priorities for packets belonging to the same type of application. Most of these applications cannot run compute intensive AI/ML tasks like object-detection, depth estimation, or path planning on resource-constrained devices, and in such cases either fully offload the AI/ML inference tasks to edge servers or split the inference between local and remote, which is termed as split inferencing. Full full-offload and split-inferencing cases the event-based dynamic and stringent QoS requirements of these applications can stress the uplink bandwidth of the wireless access networks. 5G-NR allows the flexibility of choosing an optimal configuration from an available list of different possible configurations across the different NW layers, to maintain the user QoS that conforms to one of the QoS classes (e.g., in the 3GPP 501 Table 5.7.4-1 in TS 23.501). In the current 5G NR standard, the NW relies on the WTRU reports of estimated channel conditions and the current WTRU traffic in buffer, to decide the optimal configurations for an application running in a WTRU. In scenarios where the channel conditions for the WTRU degrade, the NW can identify it from the following WTRU report on channel estimates and can then decide whether to update the NW configurations and notify the WTRU accordingly. This reactive mechanism can be slow to converge to an optimal NW configuration for the WTRU in dynamic channels with high variance in channel metrics like SINR, RSRP, RSSI, etc. and increases the probability of overshooting the QoS thresholds for WTRUs with MTC. Also, as described in the background section, HTC requirements differ fundamentally from MTC requirements, since MTC traffic can be primarily event driven with dynamic priorities for packets belonging to the same type of application.

Moreover, full offloading and split-inferencing methods that are unaware of the context of the WTRU, network and machine-task server can result in sub-optimal performance of machine task execution and network, compute and energy utilization. Full-offloading of machine-tasks involve transmitting the entire sensor data from the local edge device to a remote/edge server over the wireless network. This process relies heavily on the availability of high bandwidth and stable network connection. In real-life scenarios, the network conditions can be dynamic (e.g., urban canyon scenarios with poor connectivity, network congestion, interference, etc.), which can make task-offloading method unreliable and introduce increased latency to the overall machine-task procedure. To mitigate the drawbacks of full-offloading, split computing techniques are used which divides the AI/ML inferencing between the edge device and the edge/remote server. Performing part of the AI/ML processing on the edge device can exploit the available edge device compute capability, reduce the computation load of the edge server. This method also reduces the utilization of network resources by transmitting intermediate AI/ML data from the split inferencing head model such as feature tensors, etc., to the split inferencing tail model at the edge server to finish the rest of the inferencing, instead of sending the full sensor data from the client to the server (e.g., full offloading/edge-computing). Most of research of Split Computing for real-world systems show improvements in the latency-accuracy trade-off, where the accuracy is usually proportional to the computational load. Depending on where an AI/ML model is split into the head and tail portions, the transmission of the output of the model ‘head’ to the input of the AIML model ‘tail’ over the wireless network incurs latency. This also affects the confidence of the AIML model output which affects the task precision (e.g., navigation based on obstacle avoidance which relies on the object detection accuracy of the AIML model). Current machine-type split computing (MTSC) systems implemented in testbeds use a one-task logic (e.g., object detection only) that optimizes the tradeoff between end-to-end latency and inference performance. Complex tasks such as autonomous navigation requires multiple task inference or multiple data-type processing (e.g., object detection, classification, identification, tracking, etc.) based on the application task type, WTRU environment, WTRU behavior (e.g., mobility), behavior of objects nearby the user (e.g., mobility, direction of motion, etc.) and network conditions. This requires the need for an implementation of an adaptive logic to learn the optimal local inferencing, full-offloading and split-inferencing policy for each of the active machine-tasks that constitute a machine-type application, which meets the dynamic, event-based, custom QoS requirement of the machine-type application while also conserving network and compute resources and WTRU energy.

This disclosure aims to address these drawbacks by enabling the WTRUs to understand the context of the machine-type task performance over the network in terms of the application requirements and characteristics, server characteristics and performance, WTRU characteristics, wireless channel conditions and the NW configuration and requirements. This can enable the WTRU to learn the optimal local inferencing, full-offloading and split-inferencing policy which meets the dynamic, event-based, custom QoS requirement of MTC traffic while also conserving network and compute resources and WTRU energy. This can enable the WTRU to be aware of the changing application demands, network conditions and machine-type server performance and quickly converge to optimal task-offloading and/or split-inferencing policy for the custom and dynamic QoS requirements of these emerging applications.

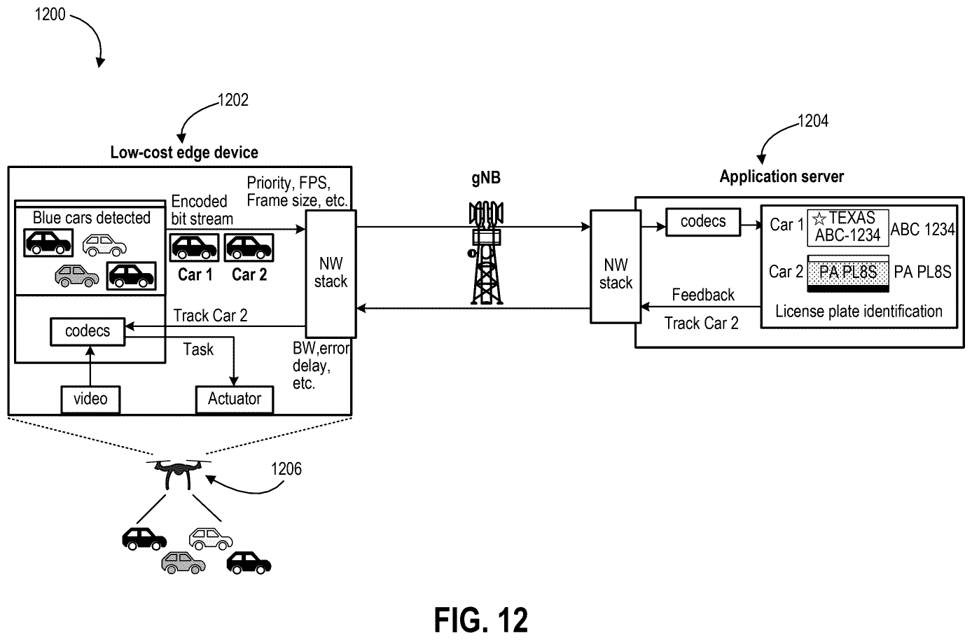

The above problem description is explained in detail below through an example MTC use case of license-plate identification for intelligent surveillance herein below with reference to FIG. 12.

FIG. 12 is a diagram 1200 illustrating an example of edge-based object classification and car license-plate identification for intelligent surveillance. In this scenario, a low-cost edge device 1202 with limited computational power and limited battery (e.g., an unmanned aerial or ground vehicle 1206) may monitor a section of a highway through video streams captured by an onboard camera. The device's lightweight AI/ML models on the device perform part of the machine-task, such as object detection whenever a vehicle is detected in a video frame. After detecting an object, the device may transmit the compressed data of the detected object to a remote server (e.g., Application server) 1204 for further processing, such as license plate detection. The edge server application may generate feedback for the device, which may include instructions on capturing future frames at specific resolutions and compression settings to improve inference confidence levels for object classification (e.g., car, motorcycle, bus, truck, etc.). The device follows the edge server's directives, sending specific video frames in the requested format. Based on the license plate identification inference results, the server may then instruct the device to take follow-up actions, such as tracking or following the identified vehicle.

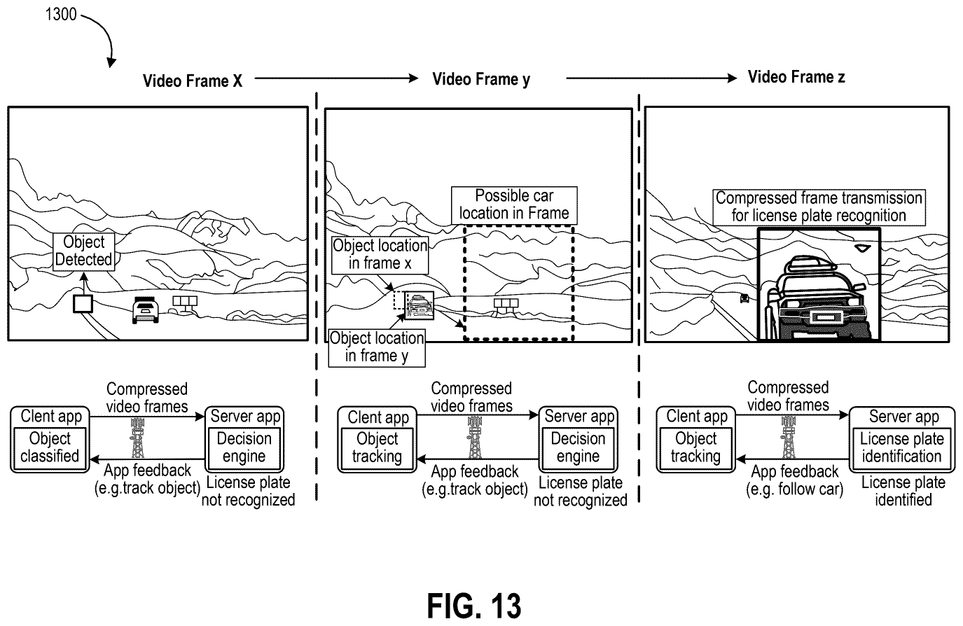

FIG. 13 demonstrates an example scenario in which video frame priority depends on the specific machine-type task, here object detection versus license plate identification. The machine-type application's QoS for round-trip time estimation, which may be particularly useful for autonomous vehicle tracking based on edge-server-based license plate identification, may vary based on factors such as the vehicle's speed, atmospheric conditions (e.g., fog, sun, rain), and the camera's field of view.

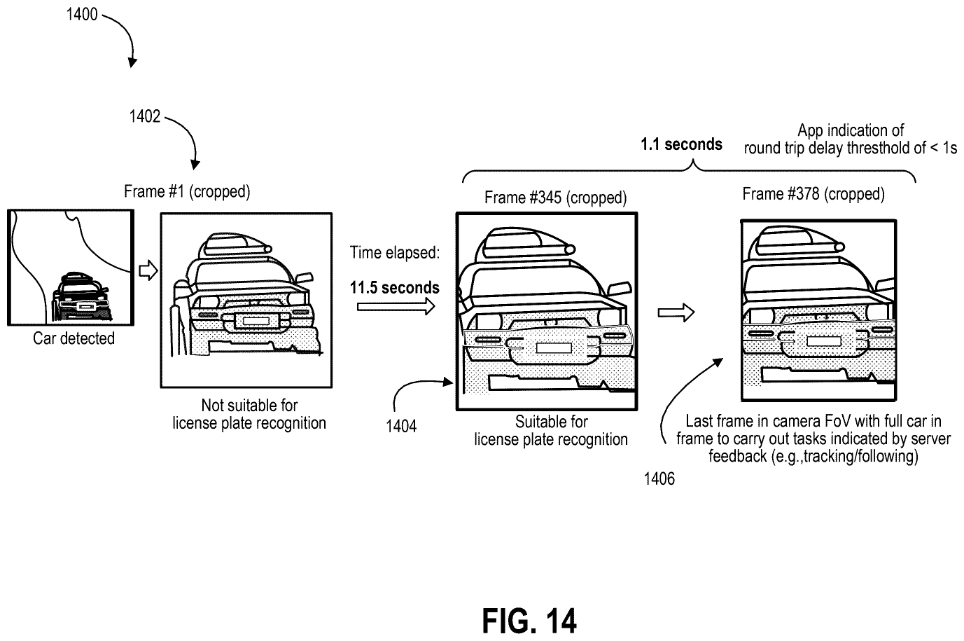

FIG. 14 presents an example for determining an estimate of the threshold round-trip time of video frame generation to inference feedback reception from a remote server for a machine-type task (e.g., an intelligent surveillance machine-type task). In the rural scenario shown in FIGS. 13 and 14, a device captures video frames at 1080p resolution and 30 frames per second. Upon detecting a car in Frame #1 (1402), the device may compress the frame and transmits it to the edge server for license plate identification. If the edge server determines the frame is unsuitable for license plate detection due to factors like vehicle distance or compression method, it instructs the device to continue transmitting frames with object detection data. The edge server subsequently directs the device to capture a future frame with a suitable compression technique, in which the vehicle is projected to be in an optimal position for object classification and license plate identification. The time window from capturing the projected frame #345 (1404) to the duration the object remains within view (e.g., from frame #345 (1404) to frame #378 (1406) may be determined by external factors like vehicle speed and camera field of view. This time frame, totaling 33 frames, dictates the required round-trip time for application response, which at 30 FPS translates to under one second. If the device does not receive inference feedback by frame #378, the feedback becomes stale as the vehicle may have moved out of view, preventing the device from preforming the task required in the feedback (e.g., follow the car). The time duration from frame #345 to frame #379 (e.g., total of 33 frames) may be calculated based on the camera frame rate (e.g., frames per second or FPS), and at 30 FPS the round-trip time may need to be less than one second.

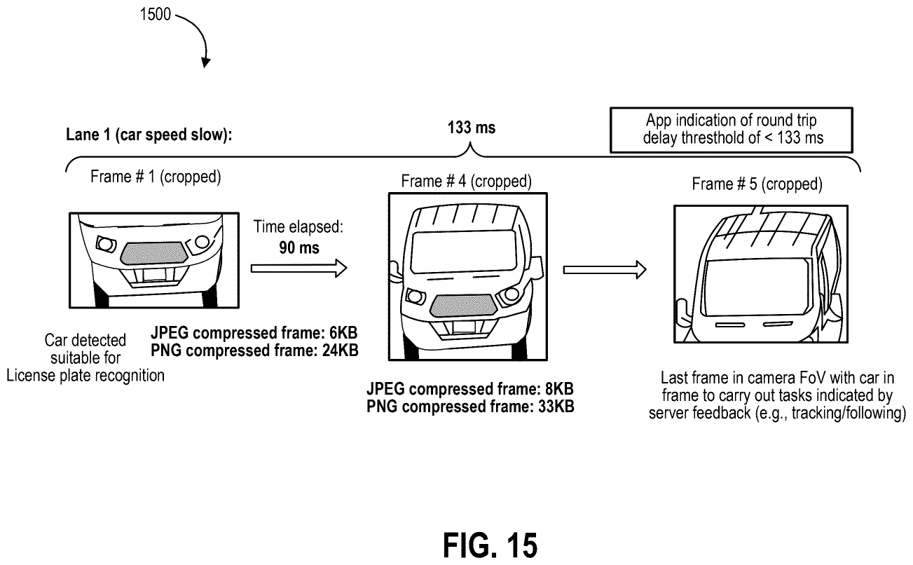

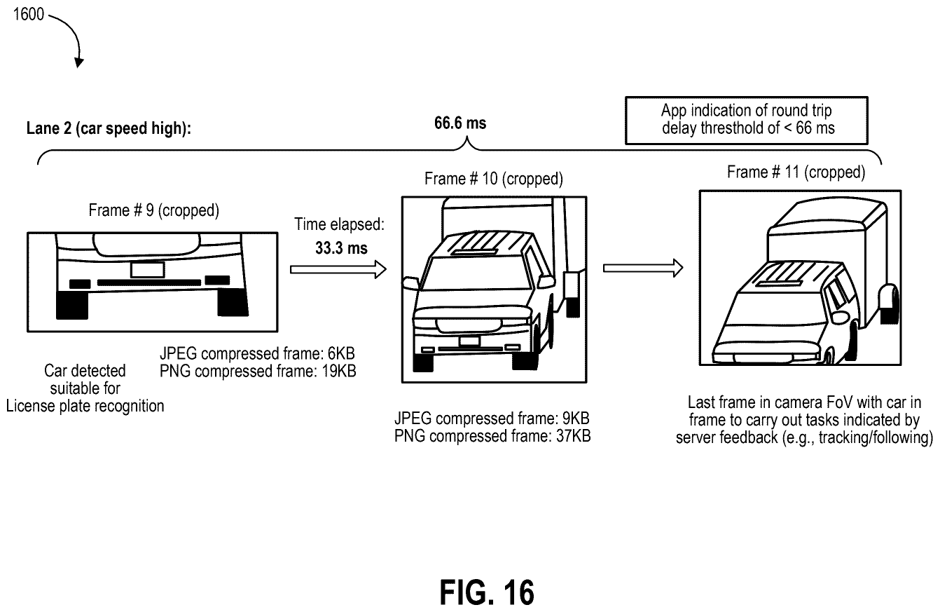

Referring now to FIGS. 15 (lane 1) and 16 (lane 2), with continued reference to FIGS. 13, and 14, FIG. 15 is a diagram 1500 illustrating an example of the dynamic nature of QoS thresholds for machine-type applications based on the WTRU's environmental characteristics, such as object speed and direction for an example lane 1, and FIG. 16 is a diagram 1600 illustrating a corresponding example for an example lane 2. In the example shown in FIG. 15, the same edge-server-assisted machine-type task of object classification and license plate identification may be performed by a low-cost edge device in a different setting than the rural setting of FIGS. 13 and 14 (e.g., a busy two-lane highway with faster-moving vehicles). Cars in lane #2 stay in view for only a few frames, while cars in lane #1 remain visible for approximately 4-5 frames. This environment requires a round-trip time of under 133 ms for lane #1 and under 66 ms for lane #2. Although the device and application remain unchanged, the WTRU's environment and object behavior affect the QoS thresholds, which are dynamic and event-driven (e.g., task execution only when objects are detected). These distinctions mark machine-type applications as different from traditional human-type applications. This shows that even if the device type and the application type remain the same, the WTRU environment and the behavior of the objects in the WTRU environment may determine the machine-type task and application QoS thresholds. Research has shown that data compression techniques may affect AI/ML inference confidence levels on compressed data. Adjusting compression techniques within the confidence threshold bounds affects application data rate, creating a custom QoS requirement over the network for edge-assisted inference scenarios. These examples show that as user behavior or WTRU environment changes, so do the machine-type application's QoS requirements, compounded by real-world dynamic network conditions.

Traditional split-computing techniques optimize latency and AI/ML model accuracy tradeoffs for single machine tasks, such as object detection. However, complex machine-type applications, such as edge-assisted navigation, may involve concurrent machine tasks (e.g., object detection, classification, identification, and/or tracking), each with specific priorities and requiring joint optimization of latency and accuracy based on network conditions and event-driven QoS demands. Configuring optimal split points manually for each AI/ML model and machine task within complex applications becomes non-scalable and challenging.

This approach allows machine-type applications to communicate with the network to understand the context of the machine-type application performance from the perspective of the WTRU, the network, the available servers and the available AIML models. This contextual awareness helps determine the optimal choice between local processing, remote processing, and adaptive split between local and remote processing, in a proactive manner that ensures the machine-type application QoS requirement is met while conserving WTRU, network, and server energy and compute resources.

In examples, a method enables the WTRU to gain awareness of the contextual factors impacting machine-type task performance by leveraging a comprehensive understanding of application requirements, network parameters, machine-type server capabilities, device characteristics, and wireless channel conditions. By incorporating this contextual awareness, the WTRU may dynamically adjust to meet custom QoS requirements for event-driven machine-type tasks. With this contextual information, the WTRU may optimize task offloading and split-inferencing decisions, conserving spectrum, computational resources, and WTRU energy, while meeting the dynamic and event-based QoS thresholds specific to machine-type tasks.

The “context” may include various factors, such as application configuration, current QoS demand, WTRU-specific characteristics (e.g., location, mobility), environmental attributes (e.g., the number and mobility of objects, atmospheric conditions), network configuration, and wireless channel conditions. This context enables WTRUs to prioritize applications, manage data flows, and handle individual data packets based on event-driven traffic demands. Additionally, it allows for resource conservation across the network, configuration of application parameters, and adaptive responses aligned with the unique QoS needs of machine-type tasks.

This approach may enable precise execution of machine tasks while optimizing compute, energy, and network resources, and upholding QoS metrics for machine-type applications, such as round-trip latency in obstacle avoidance navigation. It achieves this through continuous assessment of local and edge server computational loads (e.g., memory, GPU, CPU), network conditions (e.g., available bandwidth, channel quality), WTRU behavior (e.g., mobility), and WTRU environment characteristics (e.g., urban versus rural settings, intersection density), as well as characteristics of objects in the WTRU environment (e.g., object density and mobility).

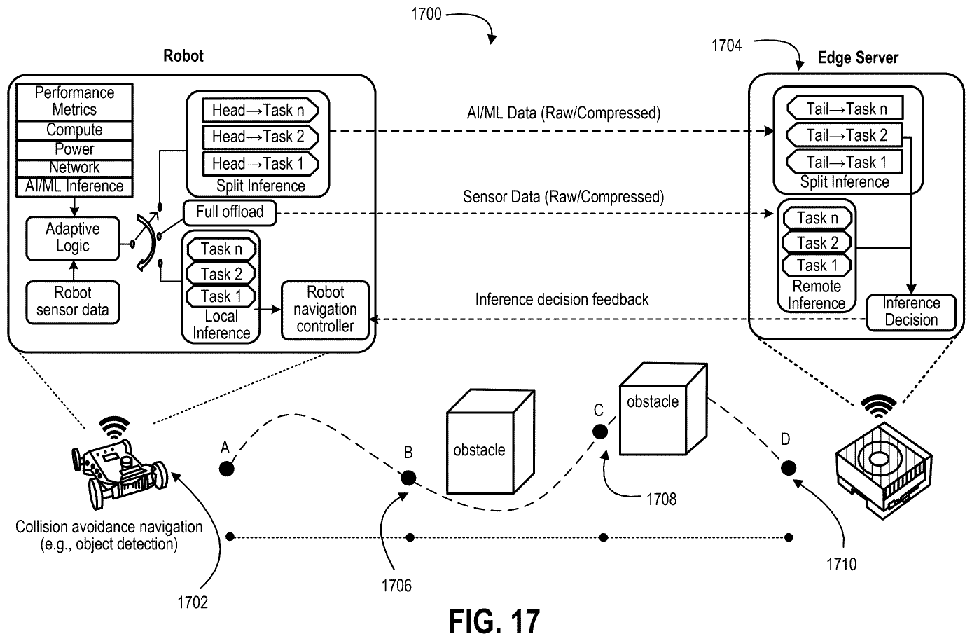

FIG. 17 is a diagram 1700 illustrating an example vehicle 1702 equipped with multiple sensors and utilizing edge computing for AI/ML-based inference to support decision-making in machine-type applications, such as collision avoidance. This system combines onboard processing with edge computing to enable efficient and adaptive navigation decisions, useful for applications that involve multiple machine tasks, including object detection, classification, identification, and tracking.

In this example, the vehicle gathers raw environmental data through sensors, which may include images from cameras, lidar scans, or other sensory inputs. While the vehicle performs certain immediate local inferences, it selectively offloads more computationally intensive AI/ML tasks to a nearby edge server 1704. This hybrid inference model balances real-time responsiveness with the capacity to process complex computations. The edge server receives raw and potentially compressed sensor data, performs remote inferences, or collaborates with the vehicle on split inference tasks, and returns vital decision feedback. This feedback guides the vehicle's navigation controller, which, working in conjunction with an adaptive logic module, plots a secure and efficient route around obstacles 1706, 1708 (e.g., ‘B’ and ‘C’ in the figure) toward its destination 1710 (‘D’).

The adaptive logic module dynamically modifies the system's behavior based on multiple performance metrics, such as computational power, energy consumption, network conditions, and AI/ML inference efficiency. This adaptability ensures optimal resource use and allows the system to optimize resource utilization and adapt to changing environmental or operational demands.

An example architecture may include several components and interactions between the vehicle and edge server to support efficient machine-type tasks. The architecture can include a vehicle, which may use sensors to collect raw data from the environment, which may include camera images, LIDAR scans, and/or other similar inputs. The vehicle may have onboard processing capability to perform certain tasks locally. A navigation controller may use sensor data and inference results to guide the vehicle's movement. Adaptive logic may dynamically adjust the system's behavior based on performance metrics, inference outcomes, and current task demands, while a transceiver may enable communication with the edge server for offloading computationally intensive tasks.

The edge server may receive raw or compressed sensor data from the vehicle, as well as AI/ML data related to different tasks. It may perform remote inference for tasks requiring more computational power than the vehicle possesses, or may engage in split inference, where part of the processing occurs on the vehicle and part on the server. The server may then send inference feedback to the vehicle, guiding its actions.

For task allocation and communication, the system may split tasks into “head” and “tail” segments, allowing distributed processing between the vehicle and edge server. Performance metrics, such as computational load, power consumption, network conditions, and AI/ML inference efficiency, may be monitored continuously to make adaptive decisions regarding task allocation and communication. As the vehicle is navigating an environment with obstacles (e.g., labeled as “B” and “C”), it may rely on its sensors for detection and on both local and remote inference to plan a collision-free path to its destination (“D”). By leveraging edge computing, the system may manage tasks in real time while adapting to environmental changes

The system may support context-aware inference by utilizing a combination of local, remote, and split inference to balance responsiveness with computational efficiency. Its adaptability, driven by adaptive logic, may allow for dynamic optimization of performance and resource usage. Edge computing may provide processing power close to the vehicle, reducing latency compared to remote cloud solutions. Split inference may further optimize resource use by distributing workloads between the vehicle and edge server, showcasing a vehicle system that leverages edge computing and adaptive decision-making to navigate its environment effectively. In examples, various functions and technologies for the system and method may operate through a combination of local computing/inference, remote computing, edge computing, edge inference, full-offloading, split inference, and/or context-aware adaptive switching between local inference, edge inference, remote inference, and/or split inference processes.

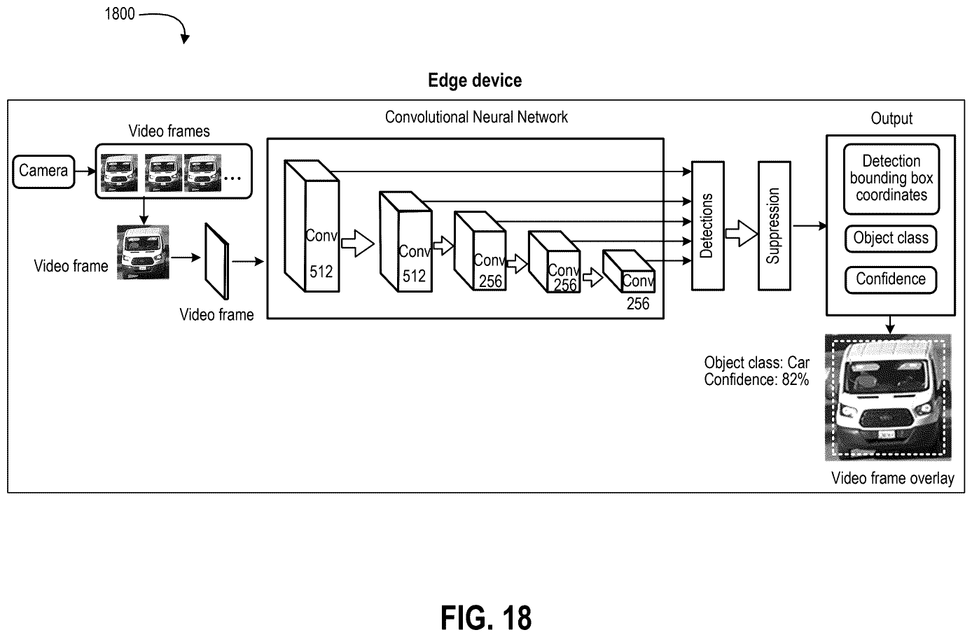

FIG. 18 is a diagram 1800 illustrating an example real-time object detection process using a Convolutional Neural Network (CNN) on an edge device (e.g., local inference). The system may take video input, process it through the CNN to identify objects, and then display the results on an edge device, demonstrating particularly useful stages involved in local inference. This process may be initiated by a camera capturing a continuous video stream, where each frame may be processed by a CNN, forming the core of the object detection pipeline. The AI/ML model architecture may be characterized by a series of convolutional layers (labeled “Conv”), with progressively decreasing numbers (e.g., 512, 256) indicating feature map size reduction in the spatial dimensions of the feature maps as the network extracts higher-level semantic information. The output of the AIML model is a set of detections, which may generate multiple detections, each represented by bounding boxes encapsulating potential objects within the scene. To refine these detections and eliminate redundant or overlapping bounding boxes, a Non-Maximum Suppression (NMS) algorithm may be applied, eliminating redundant or overlapping bounding boxes and retaining only the most confident bounding box for each detected object.

The final output may include the detected object's class label (e.g., “Car”), a confidence score for that detection (e.g., 82%), and the precise coordinates of the bounding box that localizes the object's location within the frame. This output may be overlaid on the original video frame, visually marking the detected object with a bounding box and label. This locally executed end-to-end pipeline, executed locally on the edge device, enables real-time object detection and visualization, illustrating the potential of deploying deep learning models on resource-constrained hardware for applications demanding low latency and immediate responses.

The steps for local processing may include one or more of the following. First, a camera may capture video frames. The frames may then be processed through a CNN, which has layers labeled “Conv” with decreasing numbers (e.g., 512, 256), indicating shrinking feature maps as the network goes deeper. The CNN may generate detections, which may include multiple bounding boxes around potential objects, which are then refined by Non-Maximum Suppression (NMS) to filter out redundant or overlapping bounding boxes, keeping only the most confident detections. The final output may show the detected object class (e.g., “Car”), confidence score (e.g., 82%), and bounding box coordinates to locate the object in the frame. The output may be overlaid on the original video frame, highlighting the detected object with a bounding box and label.

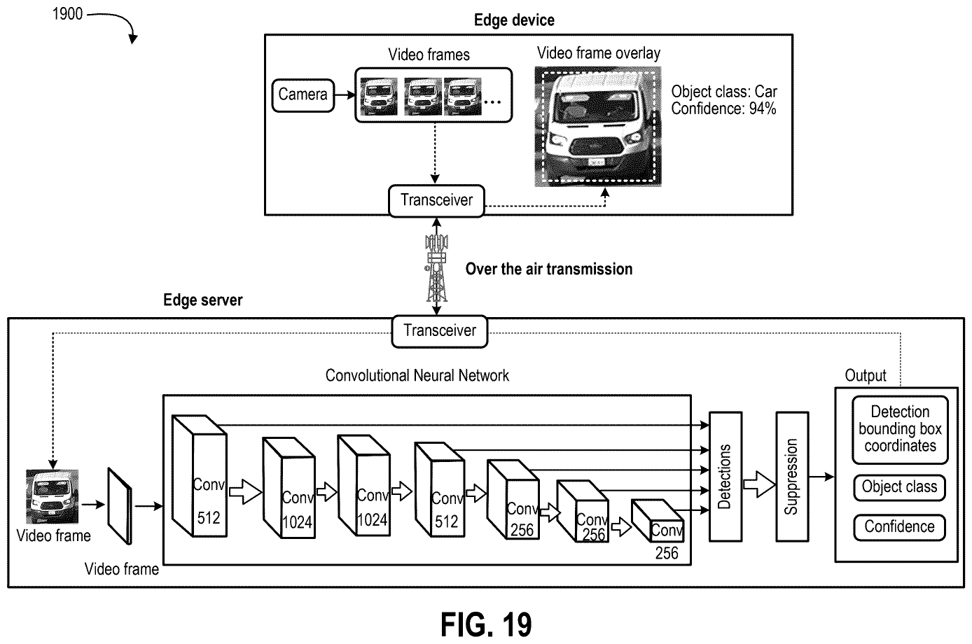

FIG. 19 is a diagram 1900 illustrating an object detection system through remote processing (full offloading) using an edge device and an edge server. Object detection may be performed by a complex CNN model on the edge server, leveraging the edge server's high compute power, improving inference accuracy while impacting the wireless spectrum usage. The CNN may be at the core of the object detection process, extracting features from images and classifying objects. Wireless communication enables real-time object detection by facilitating data exchange between the edge device and server.

FIG. 19 shows an object detection system architecture that leverages an edge server's computational capabilities to improve accuracy and real-time performance in object detection. In this configuration, an edge device equipped with a camera may capture video frames of the environment and transmit them wirelessly, potentially with compression to optimize bandwidth, to a nearby edge server. The object detection process occurs on the edge server, where a Convolutional Neural Network (CNN) processes the received video frames. The CNN architecture comprises multiple convolutional layers, labeled “Conv,” with progressively fewer filters, such as 1024, 512, and 256, to extract hierarchical features and create high-level semantic representations. To refine the network's output, a suppression mechanism (e.g., Non-Maximum Suppression (NMS)) may be applied to remove redundant or overlapping bounding boxes, retaining only the most confident detections.

The edge server then transmits the final detection results, which may include the object class, confidence score, and bounding box coordinates, back to the edge device. The edge device overlays this information onto the original video frame, providing a visual display of the detected objects in real time. This architecture exemplifies a full-offloading approach, where the computationally intensive object detection task is entirely delegated to the edge server. This strategy enhances accuracy by enabling the use of complex CNN models and improves real-time performance by reducing the computational burden on the resource-limited edge device. However, this offloading paradigm relies on reliable wireless communication, with network latency and bandwidth influencing overall system performance.

In this example, the edge device may use a camera to capture video frames, a transceiver to wirelessly transmit frames to the edge server, and a display to show the video frames overlaid with detection information, such as object class, confidence score, and bounding box coordinates. Wireless communication between the edge device and edge server enables data transmission over the air. The edge server may include a transceiver to receive frames from the edge device, and it uses a CNN model to detect objects with layers for feature extraction that progressively reduce the filter numbers, such as 1024, 512, and 256, indicating dimensionality reduction. The server's suppression mechanism (e.g., Non-Maximum Suppression), filters overlapping detections and retains only the most confident detections, and it sends the final detection results back to the edge device for display in real time.

This architecture exemplifies a full-offloading approach, wherein the computationally intensive task of object detection is delegated entirely to the edge server, capitalizing on its superior processing power. This strategy not only enhances the accuracy of object detection by enabling the use of more complex CNN models but also contributes to real-time performance by alleviating the computational burden on the resource-constrained edge device. However, this offloading paradigm inherently relies on robust wireless communication, and factors like network latency and bandwidth can influence the overall system performance.

In this example, components may include the edge device, which has a camera to capture video frames, a transceiver to send frames wirelessly to the edge server, and a display to show the final video frame overlaid with detected objects and their details (e.g., class, confidence, and/or bounding box). Over-the-air transmission is enabled by a wireless communication link between the edge device and edge server. The edge server includes a transceiver to receive video frames from the edge device and an AIML model, specifically a Convolutional Neural Network (CNN), to process the video frames for object detection. The CNN's layers perform feature extraction with decreasing numbers of filters (e.g., 1024, 512, 256), which indicates dimensionality reduction. A suppression mechanism filters out redundant or overlapping detections, and the output, including the final detection results (e.g., object class, confidence, and bounding box coordinates), is sent back to the edge device.

The workflow may proceed as follows: the camera on the edge device captures video frames, which are sent to the edge server via the transceiver. The edge server's CNN processes the frames to detect objects, and detections are refined through suppression. The results are then transmitted back to the edge device, where the detection information is overlaid on the video frame and displayed.

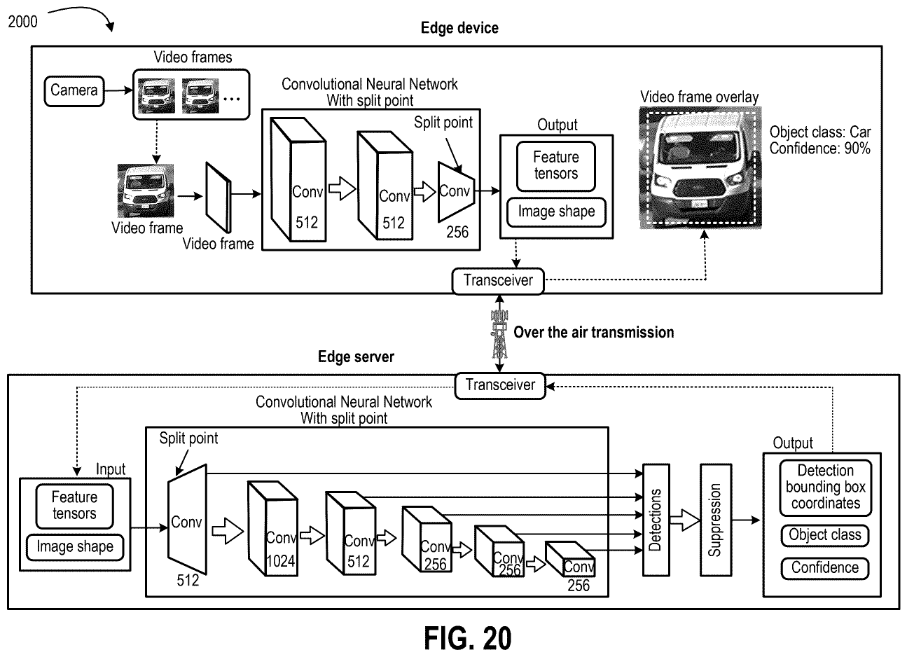

FIG. 20 is a diagram 2000 illustrating an example distributed machine-task inference system (e.g., for object detection), that may utilize both an edge device and an edge server, with a focus on dividing the CNN model between the two. The model split point may be optimized (e.g., determining where to split the model) to maximize task accuracy while conserving compute, energy, and/or network resources.

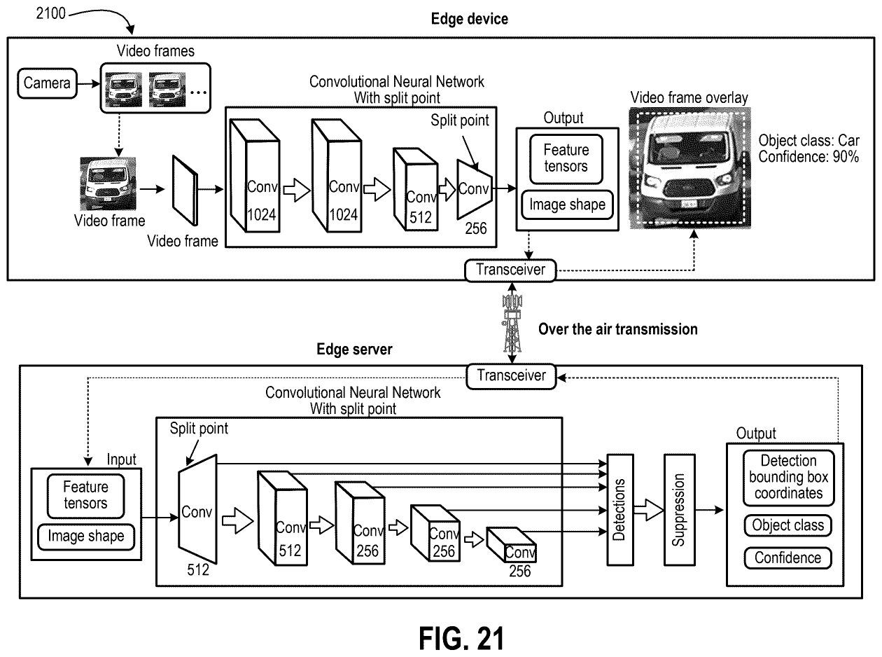

FIG. 21 is a diagram 2100 illustrating an example instance of an AIML model split at a different time instance than the example shown in FIG. 20, which can leverage a different AIML model, for the same machine-task inference (e.g., for object detection).

FIGS. 20 and 21 show an instance of an AIML model split at a different time instance, which can leverage a different AIML model for the same machine-task inference (e.g., object detection). The figures demonstrate a distributed object detection system leveraging both an edge device and an edge server, with a strategic focus on splitting the AIML model for optimized performance. The process may commence with the edge device's camera capturing video frames. These frames are then fed into the initial layers of the CNN, located on the device itself, up to a designated split point. The resulting intermediate feature tensors, along with crucial image shape information, are then transmitted wirelessly to the edge server. Here, the remaining layers of the AIML model take over, processing these tensors further to generate detections. Non-Maximum Suppression is subsequently applied to refine these detections and remove redundancies. The final output, comprising the detected object class, confidence level, and bounding box coordinates, is then transmitted back to the edge device. The device overlays this information onto the original video frame, providing real-time visual feedback of the detected objects.

This split AIML model (e.g., CNN) architecture effectively distributes the computational load between the edge device and server, utilizing the processing capabilities of both. Additionally, it reduces bandwidth requirements by transmitting only compact feature tensors rather than raw video frames. This collaborative approach, combining edge computing with strategic model partitioning, enables real-time object detection, even when the edge device has limited resources. By reducing latency and optimizing bandwidth usage, this system presents a promising solution for deploying complex machine-task inferencing models in resource-constrained environments, supporting a variety of applications such as autonomous vehicles, surveillance systems, and augmented reality.

In this example, the edge device may include a camera to capture video frames, an initial AIML model with a split point to process the initial layers of the CNN, a transceiver to send intermediate feature tensors and image shape information to the edge server, a reception component to handle the final AIML inference results (e.g., such as bounding box, object class, and confidence) from the edge server, and a video frame overlay to display the original video frame with the overlaid detection results. The edge server may include a transceiver to receive intermediate feature tensors and image shape from the edge device, the remaining AIML model with a split point to process the later layers of the CNN, a suppression mechanism to filter redundant detections, and an output that generates final detection results, which are then sent back to the edge device.

The workflow may proceed as follows: the edge device captures video frames and processes the initial part of the CNN to generate intermediate feature tensors. These tensors and image shape are sent to the edge server. Upon receipt, the edge server continues CNN processing from where the edge device left off, applies Non-Maximum Suppression to filter detections, generates the final output (e.g., object class, confidence, and bounding box), and sends the results back to the edge device. The edge device then receives the detection results, overlays them onto the original video frame, and displays it.

This split AIML model distributes computational load between the edge device and server, which for example, may allow for faster processing by performing part of the task on the device itself. By transmitting only intermediate tensors rather than the entire video frames, the approach reduces bandwidth requirements. This setup enables object detection facilitated through the combination of edge computing and wireless communication. Key advantages of this approach include reduced latency, efficient bandwidth usage, and the ability to leverage computational capabilities of both the edge device and server, creating an optimized solution for real-time object detection in scenarios where resources on the edge device may be limited.

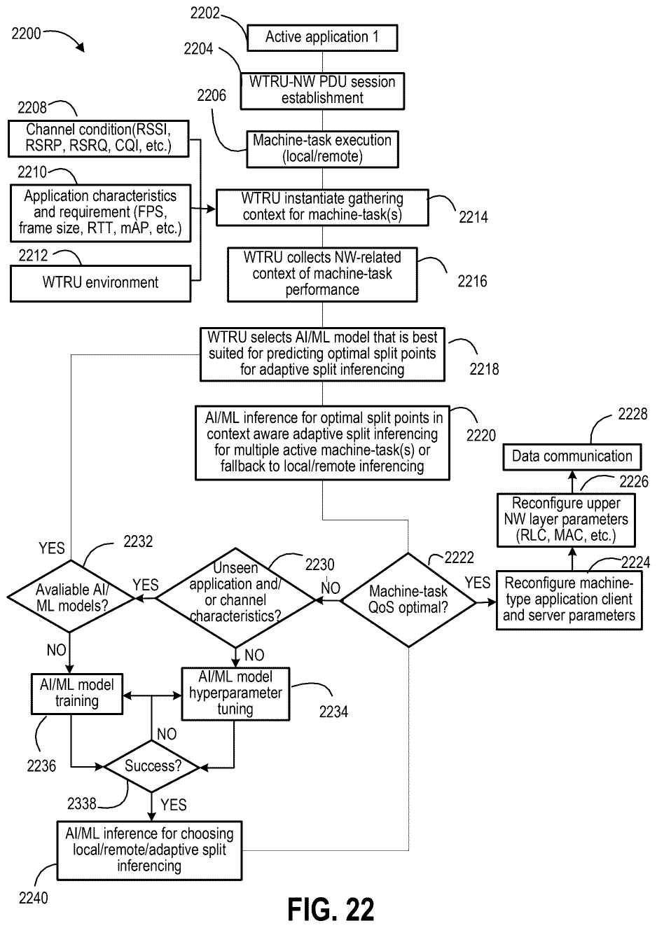

FIG. 22 is a diagram illustrating an example procedure 2200 for WTRU context aware adaptive local, remote, and split inferencing steps for multiple active machine-type tasks to accommodate dynamic and custom machine type applications QoS requirements while minimizing the impact on network, compute and WTRU energy resources.

The flowchart depicted in FIG. 22 shows the different steps for context-aware adaptive task-offloading/split-inferencing over wireless network and the interaction between the different WTRU, NW and application server components to execute and implement the process.

The diagram illustrates an adaptive decision-making framework designed to optimize the execution of machine-type tasks on a User Equipment (WTRU) by intelligently choosing between local, remote, or split inferencing. This context-aware approach considers various factors such as channel conditions (RSSI, RSRP, RSRQ, CQI), WTRU environment, and available computational resources to determine the most efficient inferencing strategy.

At 2202, an active application, referred to as Application 1, may be running on the Wireless Transmit/Receive Unit (WTRU). At 2204, a Packet Data Unit (PDU) session may be established between the WTRU and the Network (NW) for Application 1, enabling data communication for the application. At 2206, the WTRU may execute the machine task associated with Application 1, which may involve either local processing on the WTRU or remote processing on a server.

At 2208, the WTRU may gather channel condition metrics, including Received Signal Strength Indicator (RSSI), Reference Signal Received Power (RSRP), Reference Signal Received Quality (RSRQ), and Channel Quality Indicator (CQ). These metrics may provide information about the network connection quality. At 2210, the WTRU may collect application characteristics and requirements, which may include frames per second (FPS), frame size, round-trip time (RTT), and mean average precision (mAP). These parameters may help ensure the application meets its performance objectives. At 2212, the WTRU may collect data about its environment, which could include physical surroundings, mobility, and other context-specific information relevant to the machine tasks. At 2214, the WTRU may initiate the gathering of additional context information for machine tasks.

At 2216, the WTRU may collect network-related context information, including parameters and conditions that may impact the performance of the machine tasks.

At 2218, the WTRU may select an AI/ML model that is best suited for predicting optimal split points for adaptive split inferencing. This model may help the WTRU dynamically allocate portions of tasks between local and remote processing to optimize efficiency. At 2220, the WTRU may employ the selected AI/ML model to infer optimal split points for context-aware adaptive split inferencing. This step may enable the WTRU to manage multiple active machine tasks effectively, using adaptive split inferencing or, if necessary, falling back to local or remote inferencing based on the context.

At 2222, the WTRU may check whether the Quality of Service (QoS) for the machine task is optimal. If the inference precision is optimal, the process may continue to block 2224 to reconfigure upper NW layer parameters. At 2224, the WTRU may re-configure the AI/ML model parameters based on the inference precision, which may include one or more of model pruning, hyperparameter tuning, etc. At 2226, the WTRU may reconfigure upper network (NW) layer parameters, including Radio Link Control (RLC), Medium Access Control (MAC), and other relevant protocol layers, to enhance performance or meet the required QoS for machine tasks. At 2228, data communication may occur, allowing the WTRU to send or receive data relevant to the machine tasks over the established network connection. If the precision is not optimal, the process may proceed to block 2230.

At 2230, the system may check whether there are any unseen application characteristics or channel conditions that could impact task performance. If there are unseen characteristics, the process may proceed to block 2232 for AI/ML model hyperparameter tuning. If there are no unseen characteristics, the process may move directly to block 2234. At 2232, the WTRU may determine whether AI/ML models are available for the current machine tasks. If models are available, the process may advance to block 2218 for model selection. If models are not available, the process may continue to block 2236. At 2234, the WTRU may perform hyperparameter tuning on the AI/ML model to optimize its performance for specific application or channel characteristics that were previously unseen. At 2236, if there were no pre-existing models available, the WTRU may initiate training of a new AI/ML model to support the machine task requirements. At 2238, the system may check whether the AI/ML model training or hyperparameter tuning has succeeded. If successful, the process may move to block 2240 for AI/ML inference. If unsuccessful, the process may repeat the model selection, tuning, or training steps as needed. At 2240, the WTRU may perform AI/ML inference to select the most appropriate processing method, which could be local, remote, or an adaptive split inferencing approach based on the model's output.

In examples, the method may begin with the WTRU gathering contextual information about the network, application requirements, and its own capabilities. It then leverages pre-trained AI/ML models or, if necessary, trains or fine-tunes models to predict optimal split points for adaptive split inferencing. By analyzing the collected context and employing AI/ML inference, the WTRU makes informed decisions regarding task allocation. It can optimize the AIML model split and reconfigure upper network layer parameters (e.g., RLC, MAC, etc.), for example, to ensure optimal performance.

A goal of this adaptive approach is to strike a balance between meeting machine-task Quality of Service (QoS) requirements and minimizing the impact on network bandwidth, computational resources, and WTRU energy consumption. This context-aware decision-making process empowers the WTRU to dynamically adapt to varying conditions, ensuring efficient and effective execution of diverse machine-type applications while preserving valuable resources. This can be useful in scenarios where the WTRU operates in dynamic environments with fluctuating network conditions and varying application demands, as it allows for real-time adaptation and optimization of task execution.

Methods for context-aware adaptive inferencing for multiple active machine-tasks that constitute a machine-type application are described in further detail herein below.

In examples, the method may include learning, by the WTRU and/or the network (NW), the context of multiple active machine-type task performances, enabling the WTRU to adapt its machine-task inferencing method (e.g., local, remote, and/or split inferencing with adaptive split points) for these tasks to meet dynamic and/or custom machine-task QoS requirements while minimizing the impact on network, compute, and/or WTRU energy resources.

The WTRU executing machine-type tasks may learn the context related to machine-type application performance by gathering information from the application, WTRU configuration, WTRU environment, edge/remote server configuration and/or performance, and network configuration and/or performance. Based on this context, the WTRU may predict the optimal split inferencing method for each active machine task, including the ideal split points. The WTRU ultimately determines the best inferencing strategy (e.g., local, remote, and/or adaptive split) for each active machine task to meet the dynamic QoS requirements while minimizing impact on network, compute, and/or WTRU energy resources.

The WTRU client machine-type application may set up one or more connections with the remote server machine-type application and initiate data communication to execute complex edge-assisted machine-type tasks (e.g., edge-assisted navigation), which may involve different machine-type tasks such as object detection, classification, and/or tracking. The WTRU then may activate the context-gathering process to generate WTRU context related to executing machine-type tasks. This WTRU context may include, for example, application performance data, WTRU client compute performance, machine-task performance metrics, upper NW layer performance metrics, WTRU performance related to machine tasks, network-related information, WTRU-specific information, and/or a future time duration.

Application performance data may include, observed round-trip time (e.g., a time span of the application data generation to the inference feedback reception from the remote server), application round-trip time thresholds, upper/lower bounds of data rate, and/or data size. The WTRU client compute performance may include compute delay and/or computation load. The edge/remote server compute performance may include compute delay and/or computation load The machine-task performance metrics may include inference confidence level, confidence thresholds, and/or false positives and/or negatives of inference decisions. The upper NW layer performance metrics may include transport layer congestion, packet drops, RLC buffer status, and/or MAC buffer status. The WTRU performance related to machine tasks may include collision probability, power consumption, and/or battery level. The network-related information may include available bandwidth, frequency, channel quality, RSSI, RSRP, and/or path loss. The WTRU-specific information may include location, direction of motion, and/or planned trajectory. The future time duration for which the machine task will remain active may include a number of slots, frames, and/or a time period (e.g., milliseconds).

The WTRU may request network-related parameters from the NW to complete the context for machine tasks, sending this request through MAC CE, UCI, or RRC. This request may include one or more of NW one or more of NW-parameters (e.g., allocated bandwidth, WTRU upper and/or lower transmit power limits, QoS priority, NW backhaul latency, and/or packet drops, as well as the future time instances and/or duration of future time for sending the context parameters.

The NW may receive the WTRU request for context-aware optimization and may generate the NW context for serving the edge-assisted machine-type application(s). The NW may transmit the WTRU-requested NW parameters to the WTRU at the requested future time and/or for the requested duration through MAC CE, DCI, or RRC signaling. Upon receiving these NW parameters, the WTRU may construct the complete context related to the machine-task. The WTRU may predict the most optimal inferencing method for each of the active machine-tasks based on the context of the machine-task(s). In case of split inferencing, WTRU may predict the most split inferencing method(s) for executing the machine task(s) with adaptable split points and maintaining the dynamic QoS requirement(s) for the machine-task application(s).

For a transmission occasion (e.g., or for a set of transmission (Tx) occasions and/or UL transmissions), the WTRU may determine whether to use legacy local/remote inferencing or the adaptive split inferencing method based on one or more of application(s) machine-task QoS requirements, WTRU environment, WTRU mobility, WTRU power consumption, wireless channel condition, and/or current measured QoS. The application's task QoS requirements may be defined by upper and/or lower bounds of round-trip time thresholds and/or confidence thresholds. The WTRU environment may be defined by WTRU location, number of objects near the WTRU, WTRU mobility, characteristics (e.g., of objects around the WTRU like speed, direction, and/or size), and atmospheric conditions (e.g., fog, low-light, and/or sunshine) that may affect the application performance. Wireless channel condition may be defined by CQ, RSSI, RSRP, SINR, and/or path loss.

The WTRU may then transmit an indication to the NW related to the execution of the inferencing method, including, for example, regarding the machine-tasks, one or more of: an indication of duration or the number of slots, frames, and/or milliseconds for which the local, remote, and/or split inferencing method is determined to be valid (validity period), (e.g., based on the context of the machine task context). This indication may also include predicted NW requirements (e.g., bandwidth, throughput, round-trip time latency, etc.) for the split inferencing duration and may be transmitted via UCI, MAC CE, and/or RRC. The WTRU may also send an indication to the machine-task edge/remote server indicating inferencing information, including, for example the inferencing method chosen for the machine tasks, specifying the duration or slots, frames, and/or milliseconds of validity based on the machine-task context.

Based on the collected context of the machine tasks and the predicted optimal inferencing methods for the Tx durations, the WTRU may determine configurations for the upper NW layers (e.g., transport, network, SDAP, RLC, and/or MAC layers) to apply during transmission. The WTRU may then transmit in the UL with the configured values in the upper NW layers for the Tx occasions.

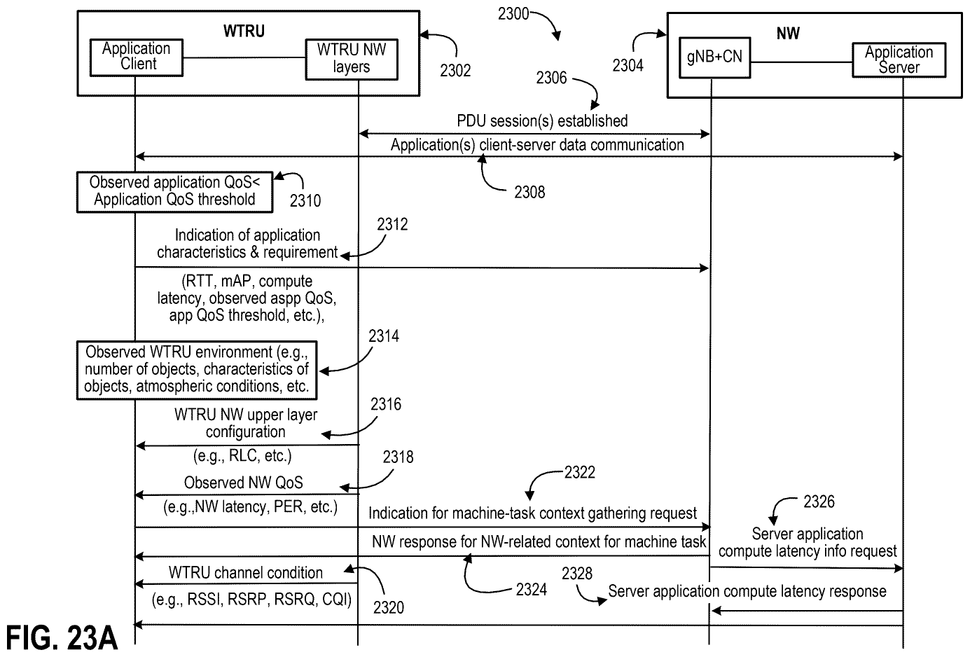

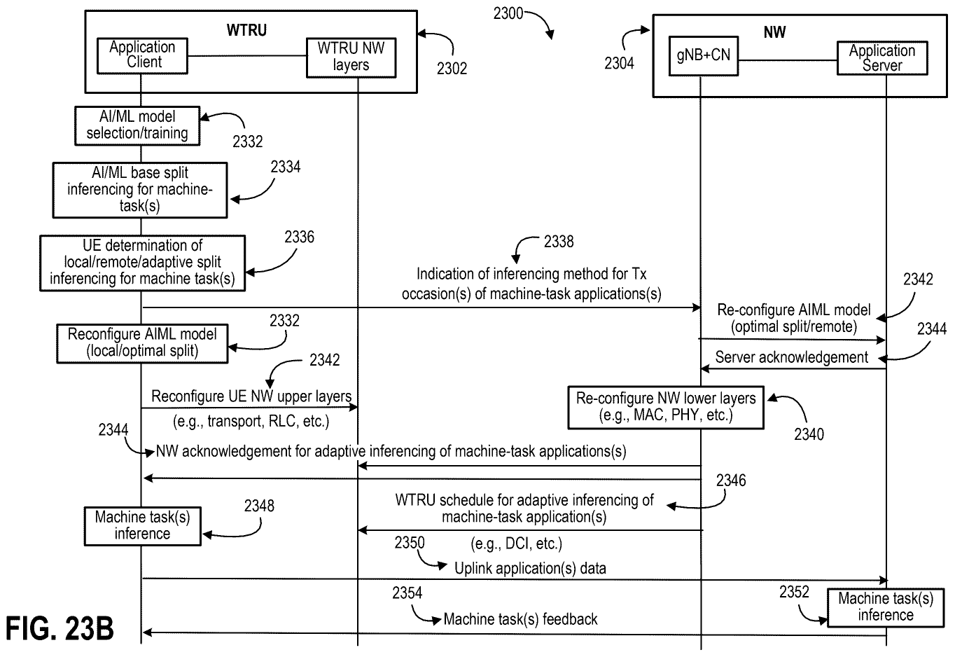

FIGS. 23A and 23B are diagrams illustrating an example of context-aware adaptive inferencing procedure 2300 that can be performed by a WTRU for multiple active machine-task applications. This approach may be utilized for dynamic and custom machine-type application QoS requirements in varying network conditions while conserving compute, energy, and network resources.

FIG. 23A may include a WTRU 2302 and NW 2304 components. The WTRU may include application clients and upper NW layers, while the NW may include the gNB and Core Network (CN) connected to an application server. At 2302, the WTRU may initiate a connection with the network, which may involve the establishment of a Packet Data Unit (PDU) session to enable data communication between the application clients on the WTRU and the application servers on the NW. At 2306, a PDU session is established, allowing the WTRU applications to engage in client-server data communication with their respective application servers on the network. At 2308, the client-server data communication for one or more applications may proceed over the established PDU session, enabling the exchange of data necessary for executing machine tasks associated with each application.

At 2310, the WTRU may observe the application's QoS and compare it against the application QoS threshold to determine whether adjustments are necessary to maintain optimal performance. At 2312, the WTRU may send an indication the NW regarding the machine-type application characteristics and requirement which may include one or more of: round trip time latency (RTT), compute latency, observed application QoS, and/or application QoS threshold. At 2314, the WTRU may gather information about its environment, which could include factors such as the number of objects in proximity, the characteristics of those objects, and atmospheric conditions. These environmental factors may impact the performance of the machine tasks. Beginning from 2316, the WTRU may start the process for building the context regarding the machine task performance. From 2316 till 2322, the WTRU collects local information to build the first part of this context. At 2316 the WTRU may gather information about the configurations of the upper NW layers, such as the Radio Link Control (RLC) layer which can provide information that includes one or more of the UE buffer space conditions, bottleneck conditions, etc. At 2318, the WTRU may observe network QoS metrics, which could include network latency and packet error rate (PER). These metrics may help assess the quality of data transmission and ensure it meets the application's requirements. At 2320, the WTRU may observe channel conditions, including metrics such as Channel Quality Indicator (CQI), Reference Signal Received Power (RSRP), and Received Signal Strength Indicator (RSSI). These channel condition observations may help the WTRU gauge the quality and stability of its network connection.

At 2322, the WTRU may send an indication to the NW to request information from the NW side (second part of the context) that may aid the WTRU to complete building the context regarding the machine task performance, that was initiated at 2316. This request may prompt the NW to assist in gathering additional context information relevant to the WTRU's task execution. At 2322, the NW may gather information about the configuration of the lower NW layers (e.g., medium access control (MAC) and/or physical (PHY) layers), that affects the data transmission performance. At 2326, the NW may send a request to the server application to obtain compute latency information, and at 2328, the server application may respond to the NW with compute latency information. At 2324, the NW may send an indication to the WTRU combining the information gathered in 2326, and 2328, providing the NW related information to the WTRU so that the WTRU can build the complete context regarding the machine task performance.

FIG. 23B may include both a WTRU 2302 and Network 2304 components. The WTRU may include application clients and the upper NW layers, while the NW may include the gNB and core network (CN) connected to an application server.

At 2302, the Wireless Transmit/Receive Unit (WTRU) may include components for Adaptive Inferencing and network layer management. The WTRU may establish a framework for adaptive inferencing and network coordination, enabling it to efficiently process machine tasks across various configurations. At 2304, the Network (NW) may incorporate components such as the gNB and Core Network (CN), as well as an application server that facilitates distributed machine task processing for tasks communicated by the WTRU.

At 2332, the WTRU may select or perform training on an AI/ML model to optimize inferencing for machine tasks, adapting processing dynamically based on current context, and model capabilities. At 2334, the WTRU may initiate split inferencing for machine tasks (the corresponding block in the Figure should be “AI/ML based split inferencing for machine tasks” instead of the incorrectly shown “AI/ML base split inferencing for machine tasks”), using the trained AI/ML model to divide processing between local (WTRU) and remote (NW/server) resources. At 2336, the WTRU may determine whether to execute machine tasks using local, remote, or adaptive split inferencing. This determination is based on contextual information and model capabilities to ensure efficient processing.

The WTRU configures the local AI/ML model for local/remote/split inferencing based on the determination made at 2336.

At 2338, the WTRU may send an indication to the NW specifying the inferencing method selected for the transmission occasions of machine task applications. This indication enables the NW to coordinate task processing with the WTRU's selected inferencing approach. At 2340, the NW may reconfigure its lower layers, such as the Medium Access Control (MAC) and Physical (PHY) layers, to support the WTRU's chosen inferencing method, thereby enhancing data transmission and optimizing resource allocation. At 2342, the NW may indicate to the server to adjust the server application settings to support machine task inference, making server-side modifications that align with the WTRU's requirements for adaptive inferencing. At 2344, the server may acknowledge the reconfiguration request, confirming that adjustments necessary for machine task inference have been applied to support the WTRU's split inferencing needs.

At 2342, the WTRU may reconfigure upper NW layers, including Transport and Radio Link Control (RLC) layers, in accordance with the chosen inferencing method (local, remote, or split). This reconfiguration optimizes data transmission for machine task processing.

At 2344, the NW may send an acknowledgment to the WTRU for adaptive inferencing of machine task applications (e.g., DCI). At 2346, the WTRU may schedule adaptive inferencing for machine-task applications, which may include coordinating timing and resources in line with the selected inferencing method.

At 2348, the WTRU may proceed with inferencing for machine tasks, executing the tasks based on the configured settings and the chosen processing method. At 2350 the WTRU may transmit sensor data through the uplink to the application server if remote inferencing decision was taken or the WTRU may transmit AI/ML tensors through the uplink to the application server if the decision was taken for split inferencing.

At 2352, the WTRU and/or the NW may perform machine task inference. This may involve local processing by the WTRU, remote processing by the NW, and/or an adaptive split inference in which portions of the task may be processed by both the WTRU and NW.

At 2354, the WTRU may receive feedback regarding the machine task inference, which may include performance metrics, inference results, and/or additional configuration recommendations from the NW or server.

1. A wireless transmit/receive unit (WTRU) comprising:
a processor configured to:
determine machine-task context information for execution of a machine-type task, wherein the machine-task context information comprises at least one of application performance information, WTRU performance information, edge server performance information, or network (NW) performance information;
receive NW-related parameters, wherein the NW-related parameters comprise at least one of channel bandwidth, WTRU transmission power limits, or end-to-end latency requirements for executing the machine-type task;
determine an inference method for the machine-type task based on the machine-task context information and the NW-related parameters; and
transmit an indication of the inference method to at least one of the NW or a remote server, wherein the indication comprises at least one of a validity period or predicted network resource requirements for the inferencing method.

2. The WTRU of claim 1, wherein the application performance information comprises at least one of observed application round trip time, application round trip time thresholds, or data size related to the machine-type tasks.

3. The WTRU of claim 1, wherein the WTRU performance information comprises at least one of compute delay or computation load related to the execution of the machine-type tasks.

4. The WTRU of claim 1, wherein the edge server performance information comprises at least one of compute delay or computation load related to the execution of the machine-type tasks.

5. The WTRU of claim 1, wherein the NW performance information comprises at least one of transport layer congestion, packet drops, or buffer status related to the execution of the machine-type tasks.

6. The WTRU of claim 1, wherein the NW-related parameters comprise at least one of allocated bandwidth, NW backhaul latency, or packet drops.

7. The WTRU of claim 1, wherein the processor is configured to:
determine the validity period of the inference method based on at least one of a number of slots, frames, or milliseconds for which the local, remote, or split inferencing method is determined to be valid.

8. The WTRU of claim 1, wherein the processor is configured to:
determine the inference method based on at least one of machine-task quality of service (QoS) requirements, a WTRU environment, or a wireless channel condition, wherein the inference method comprises local inferencing, remote inferencing, or split inferencing.

9. The WTRU of claim 8, wherein:
the WTRU environment comprises at least one of a WTRU location, a number of objects near the WTRU, characteristics of the objects near the WTRU, or atmospheric conditions that affect machine-task application performance; and
the wireless channel condition comprises at least one of a channel quality indicator (CQ), a reference signal received power (RSRP), or a path loss.

10. The WTRU of claim 1, wherein the indication of the inference method comprises at least one of predicted bandwidth requirements, throughput, or expected round-trip time for executing the inference method.

11. A method implemented by a wireless transmit/receive unit (WTRU), the method comprising:
determining machine-task context information for execution of a machine-type task, wherein the machine-task context information comprises at least one of application performance information, WTRU performance information, edge server performance information, or network (NW) performance information;
receiving NW-related parameters, wherein the NW-related parameters comprise at least one of channel bandwidth, WTRU transmission power limits, or end-to-end latency requirements for executing the machine-type task;
determining an inference method for the machine-type task based on the machine-task context information and the NW-related parameters; and
transmitting an indication of the inference method to at least one of the NW or a remote server, wherein the indication comprises at least one of a validity period or predicted network resource requirements for the inferencing method.

12. The method of claim 11, wherein the application performance information comprises at least one of observed application round trip time, application round trip time thresholds, or data size related to the machine-type tasks.

13. The method of claim 11, wherein the WTRU performance information comprises at least one of compute delay or computation load related to the execution of the machine-type tasks.

14. The method of claim 11, wherein the edge server performance information comprises at least one of compute delay or computation load related to the execution of the machine-type tasks.

15. The method of claim 11, wherein the NW performance information comprises at least one of transport layer congestion, packet drops, or buffer status related to the execution of the machine-type tasks.

16. The method of claim 11, wherein the NW-related parameters comprise at least one of allocated bandwidth, NW backhaul latency, or packet drops.

17. The method of claim 11, further comprising:
determining the validity period of the inference method based on at least one of a number of slots, frames, or milliseconds for which the local, remote, or split inferencing method is determined to be valid.

18. The method of claim 11, further comprising:
determining the inference method based on at least one of machine-task quality of service (QoS) requirements, a WTRU environment, or a wireless channel condition, wherein the inference method comprises local inferencing, remote inferencing, or split inferencing.

19. The method of claim 18, wherein:
the WTRU environment comprises at least one of a WTRU location, a number of objects near the WTRU, characteristics of the objects near the WTRU, or atmospheric conditions that affect machine-task application performance; and
the wireless channel condition comprises at least one of a channel quality indicator (CQ), a reference signal received power (RSRP), or a path loss.

20. The method of claim 11, wherein the indication of the inference method comprises at least one of predicted bandwidth requirements, throughput, or expected round-trip time for executing the inference method.
